(19) United States
(12) Patent Application Publication
(10) Pub. No.: US 2023/0216023 A1
(43) Pub. Date: Jul. 6, 2023

(54) ANODE PIECE FOR LITHIUM BATTERY HAVING BOTH HIGH SAFETY AND HIGH CAPACITY, AND PREPARATION METHOD AND USE THEREFOR

(71) Applicant: BEIJING WELION NEW ENERGY TECHNOLOGY CO., LTD, Beijing (CN)

(72) Inventors: Wenjun LI, Beijing (CN); Qiufeng DING, Beijing (CN); Hao YANG, Beijing (CN); Hangyu XU, Beijing (CN); Haiyun MA, Beijing (CN); Zepeng DING, Beijing (CN); Yadan WANG, Beijing (CN); Yongwei LI, Beijing (CN); Huigen YU, Beijing (CN)

(73) Assignee: BEIJING WELION NEW ENERGY TECHNOLOGY CO., LTD, Beijing (CN)

(21) Appl. No.: 17/927,456

(22) PCT Filed: May 26, 2021
(86) PCT No.: PCT/CN2021/095929

§ 371 Date: Nov. 23, 2022

(30) Foreign Application Priority Data
May 27, 2020 (CN) 202010464210.1
May 27, 2020 (CN) 202010464212.0
May 27, 2020 (CN) 202010464214.X

(51) Int. Cl. H01M 4/36; H01M 4/505; H01M 10/0562; H01M 10/052; H01M 4/131; H01M 4/525

(52) U.S. Cl. CPC H01M 4/364; H01M 4/131; H01M 4/505; H01M 4/525; H01M 10/052; H01M 10/0562; H01M 2004/021; H01M 2300/0071

(57) ABSTRACT

An anode piece for a lithium battery having both high safety and high capacity, and a preparation method and a use therefor, the anode piece being mixed with a lithium-rich compound, the lithium-rich compound being at least one selected from lithium-rich manganese-based solid solution, a lithium-rich solid electrolyte or a lithium-separated silicon oxide. Li ions can be pulled away from the lithium-rich compound in extreme conditions such as overcharging, internal short circuiting, external short circuiting, thermal abuse, piercing, compressing or overheating, thereby filling in lithium vacancies in the anode material, stabilizing the crystal lattice structure of the anode material, improving safety performance in a battery manufactured by using the material, and allowing the anode piece to maintain excellent cycle performance at higher area capacities.

### CROSS REFERENCE TO RELATED APPLICATIONS

The application claims priorities to the following Chinese patent applications: the Chinese Patent Application No. 202010464210.1, entitled “Ternary positive piece for lithium battery with high safety, high capacity and long cycle as well as preparation method and application of ternary positive piece”, filed to the China National Intellectual Property Administration (CNIPA) on May 27, 2020; the Chinese Patent Application No. 202010464212.0, entitled “Ternary positive piece for lithium battery with high safety and high capacity as well as preparation method and application of ternary positive piece”, filed to the CNIPA on May 27, 2020; and the Chinese Patent Application No. 202010464214.X, entitled “Positive piece for lithium battery with high safety and high capacity as well as preparation method and application of positive piece”, filed to the CNIPA on May 27, 2020; and the content of the Chinese patent applications is entirely incorporated herein by reference.

### FIELD

The present disclosure pertains to the technical field of battery materials, and relates to an positive piece for a lithium battery having both high safety and high capacity and a preparation method and a use thereof.

### BACKGROUND

The energy and environment are fundamental conditions for the survival and development of the current human society, and form the fundamental material basis which supports the national construction and economic development in China, and constitute the two contradictory and difficult problems all around the world today. Along with the development of science and technology, especially the rapid growth of automobiles, the gradual depletion of traditional energy and serious pollution of environment have seriously affected the survival and development of human society in recent years. However, a novel and green energy technology is being developed and utilized, the Lithium-ion batteries are widely applied due to the advantages of long service life, high operating voltages and high energy density.

Under the current social environment that the energy crisis and the environmental problem are more and more prominent, new energy vehicles have gradually dominating the mainstream trend of the development of the automobile industry. When the new energy vehicles are put into use, the vehicles can reduce the dependency on petroleum and other fossil fuels, and effectively reduce the emission of greenhouse gases and standard pollutants. It is well-known that the Lithium-ion batteries have been extensively used in portable electronic products in recent years, and are starting its vigorous development toward the power battery and the medium-large size battery, such a trend not only poses great challenges to the cycle life, service life, and manufacturing costs of the Lithium-ion batteries, but also imposes higher requirements to the safety performance of the Lithium-ion batteries.

Lithium-ion batteries have the advantages such as high energy density, desirable cycle performance, long service life, low self-discharge, no memory effect, and exhibit a wide application prospect in the field of power batteries. When an electric vehicle is used as a transportation tool, its driving mileage and safety performance have attracted great concerns, the properties mainly depend on the performance of power batteries in terms of the energy density, cycle life, power density, safety performance and the like.

Nickel (Ni)-containing ternary materials systems have significant advantages in terms of power density of the power cells and driving mileage of electric vehicles, especially the lithium ternary nickel cobalt manganate and the lithium nickel cobalt aluminate materials having a high nickel content, thus the ternary materials systems have widespread application prospect in the field of power cells. The ternary material has advantages such as high specific capacity per gram, long cycle life, excellent low temperature performance, abundant and available raw materials, and can simultaneously overcome the defects such as low capacity of lithium iron phosphate, high costs of lithium cobalt oxide materials, poor stability of lithium manganate materials, thus is generally considered as one of the most promising anode materials for power-type lithium batteries, the high nickel ternary material has promising application prospect in the technical field of electric vehicles; however, the high nickel ternary materials have the defects such as poor high temperature stability, being prone to suffer from thermal runaway, and the higher is the nickel content in the ternary material, the worse is the thermal stability. As a result, improving safety performance of ternary anode materials is vital for the wide-spread use of high energy density lithium ternary batteries in the field of power cells, it is also one of the hot directions of industrial researches at present.

Despite so many advantages of the ternary anode material, the material has the defects such as poor high temperature stability, being susceptible to thermal runaway, and the higher is the nickel content in the ternary material, the worse is the thermal stability. As a result, improving safety performance of ternary anode materials is vital for the wide-spread application of high energy density lithium ternary batteries in the field of power cells, it is also one of the hot directions of the current researches.

Taking the ternary material lithium manganese cobaltate as an example, the reasons for its poor safety performance may be as follows:

1) The lithium nickel manganese cobaltate has a lower thermal decomposition temperature, a higher amount of heat release, and poor thermal stability of the material; when compared with lithium iron phosphate, the lithium nickel manganese cobaltate has a deoxygenation temperature of 200° C. and a heat release more than 800 J/g, while the lithium iron phosphate has a deoxygenation temperature of 270° C. and a heat release only 124 J/g, and a large scale decomposition is merely performed at a temperature above 400° C.; and 2) the lithium nickel manganese cobaltate is relatively active, has strong oxidizing properties at high potentials, and the material per se is unstable and apt to oxygen evolution, thereby carry out side reactions with the electrolyte, release large amounts of heat, which is prone to cause thermal runaway, and also results in the decreased cycle life and shelf life of the ternary anode material.

The above problems are key reasons causing deterioration in safety performance of a ternary lithium battery, as a result, how to effectively address the safety hazards of a ternary battery and prevent thermal runaway phenomenon of the battery have been the problems that shall be urgently solved by the enterprises in China and foreign countries.

The current methods for improving the safety performance of a lithium battery are mainly anode material coating, electrolyte additive, PTC (Positive Temperature Coefficiency) coating, insulation/fire-retardant coating, ceramic diaphram coating, cathode material modification and the like. For example, CN103151513B discloses a high-performance ternary power battery and preparation method thereof, it discloses a lithium nickel cobalt manganate ternary material coated with Al₂O₃ for improving the safety performance of a ternary battery, but the invention has relatively limited effect on safety performance improvement at high temperature. CN104409681A discloses a preparation method of Lithium-ion battery pole piece containing a PTC coating, it discloses that the method comprises the following steps: before coating a current collector with a slurry comprising an anode or a cathode active substance, coating the current collector with a precoated layer having a temperature sensitivity in advance, wherein the precoated layer has desirable electric conductivity under the normal temperature, when the temperature increases, the resistance rises sharply to prevent the battery from further heating up, thereby improving the safety performance of a Lithium-ion battery. However, since the piercing thermal runaway occurs instantly, it is too late for the action mechanism of said coating to take effect, thus the coating cannot effectively improve piercing safety performance of the Lithium-ion battery. In addition, the above-mentioned methods such as anode material coating, ceramic diaphram coating, an use of electrolyte additive, construction of PTC coating, formation of insulation or fire-retardant coating, will reduce the electrochemical performance of the positive piece on the one hand, thus the overall performance of the anode material modified by the methods shall be further optimized; on the other hand, the methods have some effect on the preparation process of electrode or battery cell, are not conducive to the large scale production. CN107768647A discloses a high-safety coated type high-nickel ternary cathode pole piece, comprising a cathode layer made of a high-nickel ternary cathode material, and a coating layer coated on a surface of the cathode layer, the coating layer is prepared from the following raw material in percentage by mass:1-95% of inorganic flame retardant, 1-95% of inorganic phase-change material, and 1-20% of high-thermal conductivity inorganic material; the inorganic flame retardant is one or more selected from the group consisting of aluminum hydroxide, magnesium hydroxide, ammonium polyphosphate, antimony oxide, zinc borate and molybdenum-containing inorganic compounds; the inorganic phase-change material is one or more selected from a mixture or a composite formed from one or more of AlCl₃, LiNO₃, NaNO₃, KNO₃ and NaNO₂, and the molten salt compounds; the high-thermal conductivity inorganic material is one or more selected from the group consisting of graphite, graphene, carbon nanotube and aluminum nitride; the high nickel ternary cathode material is selected from lithium nickel cobalt manganate and/or lithium nickel cobalt aluminate; the solution does not fundamentally avoid the instability of the high nickel material in the high oxidation state.

Therefore, it still has an important significance to develop an positive piece for a lithium battery having both high safety and high capacity in the extreme condition such as overcharging, high temperature, piercing, compressing, internal short circuiting, external short circuiting, thermal abuse or overheating.

### SUMMARY

The present disclosure aims to provide an positive piece for a lithium battery having both high safety and high capacity, and a preparation method and a use therefor; the positive piece for a lithium battery is doped and mixed with a lithium-rich compound, the lithium-rich compound being at least one selected from lithium-rich manganese-based solid solution, a lithium-rich solid electrolyte and a lithium-separated silicon oxide. Lithium-ions can be pulled away from the lithium-rich compound in extreme conditions such as overcharging, high temperature, piercing, compressing, internal short circuiting, external short circuiting, thermal abuse or overheating, thereby filling in lithium vacancies in the anode material, reducing the oxidized state of anode under the extreme conditions, stabilizing the crystal lattice structure of the anode material, improving safety performance in a battery manufactured by using the material, and allowing the positive piece for a lithium battery to maintain excellent cycle performance at higher area capacities, allowing the battery to achieve high safety performance while maintaining the high specific energy and desirable cycle life.

The high safety described herein refers to that the positive piece for a lithium battery contains a lithium-rich compound which still pulls away Lithium-ions under external conditions such as overcharge, high temperature, piercing, compressing, internal short circulating, external short circulating, thermal abuse or overheating, thereby significantly improving the safety performance of the battery made therefrom, enabling the battery to pass the piercing test, 190° C. hot box test, without outbreak of a fire and an explosion in the process.

The high capacity described herein means that the area capacity of the positive piece for a lithium battery can reach 4 mAh/cm² or more.

To achieve the inventive object, the present disclosure adopts the following technical solution:

In a first aspect, the present disclosure provides an positive piece for a lithium battery, wherein the positive piece for a lithium battery is doped and mixed with a lithium-rich compound, which is at least one selected from the group consisting of a lithium-rich manganese-based solid solution, a lithium-rich solid electrolyte and a lithium-separated silicon oxide.

The lithium-rich compound of the present disclosure can pull away Lithium-ions in extreme conditions such as overcharging, high temperature, piercing, compressing, internal short circuiting, external short circuiting, thermal abuse or overheating, thereby filling in lithium vacancies in the anode material, stabilizing the crystal lattice structure of the anode material, improving safety performance in a battery manufactured therefrom, and allowing the positive piece for a lithium battery to maintain excellent cycle performance at high area capacity.

Existing high nickel ternary positive pieces exhibit very strong oxidizability under extreme conditions, and the dissolution of transition metals causes instability of the material structure and oxygen evolution of the anode material, which can carry out side reactions with the electrolyte and release large amounts of heat, and easily result in thermal runaway, thereby causing safety problems.

The positive piece of the present disclosure is doped and mixed with a lithium-rich compound, which can stabilizes the content of lithium in the anode, improves the overall thermal stability of the anode and further improves the safety performance of the battery in the state of extreme conditions.

Preferably, the lithium-rich compound is capable of pulling away Lithium-ions under extreme conditions of battery.

Preferably, the extreme conditions of battery include at least one of overcharging, high temperature, piercing, compressing, internal short circuiting, external short circuiting, thermal abuse or overheating.

Preferably, the lithium-rich manganese-based solid solution is represented by the molecular formula xLi₂MnO₃ · (1-x)LiMO₂, wherein 0<x≤1, such as 0.1, 0.2, 0.3, 0.4, 0.5, 0.6, 0.7, 0.8 or 0.9 and so on, preferably 0.9-1.0, and M is at least one selected from Ni, Co or Mn.

The lithium-rich manganese-based solid solution used herein as a lithium-rich compound is different from the existing anode material, it is a two-phase solid solution (consisting of Li2MnO₃ and LiNiₓCoMn_{1-x-y}O₂).

Preferably, the lithium-rich solid electrolyte is selected from Li₇La₃Zr₂O₁₂ and materials obtained after subjecting Li₇La₃Zr₂O₁₂ to doping with other element, wherein the doping element is at least one selected from the group consisting of La, Nb, Sb, Ga, Te, W, Al, Sn, Ca, Ti, Hf and Ta.

Preferably, the lithium-separated silicon oxide is represented by the molecular formula LiₓSiO_{y}, wherein x is selected from a range of 1.4-2.1, such as 1.5, 1.6, 1.7, 1.8, 1.9 or 2 and so on; and y is selected from a range of 0.9-1.1, such as 0.92, 0.95, 0.98, 1, 1.02 or 1.08 and so on.

The lithium-separated silicon oxide in the present disclosure is represented by the molecular formula, wherein x is selected from a range of 1.4-2.1, and y is selected from a range of 0.9-1.1, the aforementioned arrangement can facilitate the battery to timely pull away Lithium-ions under the extreme conditions such as overcharging, high temperature, piercing, compressing, internal short circuiting, external short circuiting, thermal abuse or overheating, so as to maintain the balance of Lithium-ions in the positive electrode, improve the thermal stability of the positive electrode, such that the battery has high safety performance in the extreme conditions.

Preferably, the lithium-rich compound has a particle diameter D50 within a range of 0.1-10 µm, such as 0.5 µm, 1 µm, 2 µm, 3 µm, 4 µm, 5 µm, 6 µm, 7 µm, 8 µm or 9 µm and so on, preferably a D50 within a range of 0.5-2 µm.

The particle diameter of the lithium-rich compound defined herein is within a range 0.1-10 µm, which is conducive to pull away Lithium-ions under the extreme conditions of battery, maintain the content of lithium in the positive electrode, thereby achieving a high safety effect; when the particle diameter is less than 0.1 µm, the interface resistance becomes large, and the ion transport in the positive piece is affected; when the particle diameter is larger than 10 µm, its effect of separating the anode active material particles is not obvious, thus the safety performance of the battery is not significantly improved.

Preferably, the percentage content by mass of the lithium-rich compound is 0.1-20%, such as 0.5%, 1%, 2%, 3%, 4%, 5%, 7%, 9%, 10%, 12%, 14%, 16% or 18% and so on, preferably 1-5%, based on the sum 100% of the mass of the anode active material and the lithium-rich compound in the positive piece for a lithium battery.

Provided that the doped and mixed amount of the lithium-rich compound in the present disclosure is within the above-mentioned range, it is advantageous for the battery to maintain the content of lithium in the positive electrode under the extreme conditions, thereby producing the effect of high safety; when the percentage content by mass of the lithium-rich compound is less than or equal to 0.1%, it provides a limited amount of lithium, and its effect of improving the safety performance of the high-energy battery is not significant; when the percentage content by mass of the lithium-rich compound is greater than or equal to 20%, it will reduce the percentage content of the anode active material, thereby reducing the energy density of the battery.

Preferably, the positive piece for a lithium battery has an area capacity larger than or equal to 4 mAh/cm², such as 5 mAh/cm², 6 mAh/cm², 7 mAh/cm², 8 mAh/cm², 9 mAh/cm² or 10 mAh/cm² and so on.

The lithium-rich compound is doped and mixed with the positive piece of present disclosure, it can significantly improve cycle performance of the positive piece at a high area capacity.

Preferably, the anode active material in the positive piece for a lithium battery is represented by the molecular formula LiNiₓCo_{1-x-y}M_{y}O₂, where x ≥ 0.8, such as 0.8, 0.83, 0.85, 0.88, or 0.90 and so on; y ≤ 0.2, such as 0.05, 0.08, 0.1, 0.13, 0.15, 0.18, or 0.2 and so on; and M is any one of Mn, Al or Mg, or a combination of at least two thereof. The combinations illustratively include a combination of Mn and Al, a combination of Mg and Mn, or a combination of Al and Mg.

In a second aspect, the present disclosure provides a method for preparing an positive piece for a lithium battery according to the first aspect, comprising: premixing an anode active material with a lithium-rich compound to obtain a premixed powder; and
blending the premixed powder, a glue solution and a conductive agent to obtain an anode sizing agent; and
coating the anode sizing agent on a current collector to obtain a coated current collector, subjecting the coated current collector to drying, cold pressing and tableting process, so as to prepare the positive piece for a lithium battery.

Preferably, the premixed powder, the glue solution and the conductive agent are blended in such a manner that the glue solution is added to the premixed powder, the conductive agent is then added to obtain the anode sizing agent.

In a third aspect, the present disclosure provides a battery comprising an positive piece for a lithium battery according to the first aspect.

Preferably, the battery further comprises a negative piece, a cathode active material in the negative piece is selected from silicon oxide and/or silicon carbon.

Preferably, the negative piece comprises a cathode active material, a conductive agent, a thickening agent and a binder.

Preferably, the battery further comprises a diaphram.

Preferably, the diaphram is selected from diaphrams coated with a ceramic interlayer.

Preferably, the diaphram has a thickness of 10-40 µm, such as 12 µm, 15 µm, 18 µm, 20 µm, 22 µm, 25 µm, 28 µm, 30 µm, 32 µm, 35 µm or 38 µm and so on; and a porosity of 20-60%, such as 25%, 30%, 35%, 40%, 45%, 50% or 55% and so on.

Preferably, the battery further comprises an electrolyte, which includes a lithium salt, a solvent and a film forming additive.

Preferably, the lithium salt is any one of LiPF₆, LiBF₄ or LiClO₄ or a combination of at least two thereof, the combination illustratively includes a combination of LiPF₆ and LiBF₄, a combination of LiClO₄ and LiPF₆, a combination of LiBF₄ and LiClO₄.

Preferably, the solvent is at least one selected from the group consisting of ethylene carbonate, propylene carbonate, dimethyl carbonate, methyl ethyl carbonate and fluoroethylene carbonate.

Preferably, the film forming additive is selected from VC and/or PS.

It is another object of the present disclosure to provide a ternary positive piece for a lithium battery having both high safety and high capacity, a preparation method and a use thereof, the ternary positive piece comprises a current collector and an anode active material layer disposed on a surface of the current collector, wherein the anode active material layer comprises an oxide solid electrolyte capable of transporting Lithium-ions, the oxide solid electrolyte is composed of porous spherical particles. The porous spherical oxide solid electrolyte is dispersed in the anode active material layer in the ternary positive piece of the present disclosure, it can significantly improve the safety performance of a lithium battery, such that the lithium battery prepared therefrom has an obviously increased passing rate for the piercing, heating and deformation compression tests, and has a high specific capacity, the specific capacity of the prepared lithium battery may be 300 Wh/kg or more.

The high safety described herein refers to that the lithium battery made from the ternary positive piece of the present disclosure can pass a piercing test, a test of heating at 180° C. for 2 h, and a test of 50% deformation compression;

The high capacity described herein means that the area capacity of the ternary positive piece of the present disclosure may be 4 mAh/cm² or more.

To achieve the inventive object, the present disclosure adopts the following technical solutions:

In a first aspect, the present disclosure provides a ternary positive piece for a lithium battery having both high safety and high capacity, the ternary positive piece comprises a current collector and an anode active material layer disposed on a surface of the current collector, wherein the anode active material layer comprises an oxide solid electrolyte capable of transporting Lithium-ions, the oxide solid electrolyte is composed of porous spherical particles.

The porous spherical oxide solid electrolyte is dispersed in the anode active material layer in the ternary positive piece of the present disclosure, it can significantly improve the safety performance and capacity of a lithium battery obtained from the ternary positive piece, the obtained lithium battery can pass a piercing test, a test of heating at 180° C. for 2 h, and a test of 50% deformation compression. The energy density of the produced lithium battery may be up to 300 Wh/Kg.

The lithium battery obtained from the ternary positive piece of the present disclosure has superior cycle performance under the condition of high area capacity.

Preferably, the porous spherical particles have a porosity within a range of 5-70%, such as 5%, 10%, 15%, 20%, 25%, 30%, 35%, 40%, 45%, 50%, 55%, 60%, 65%, 70% and so on, preferably 40-70%.

Preferably, the oxide solid electrolyte has a particle diameter within a range of 0.1-10 µm, such as 0.2 µm, 0.3 µm, 0.4 µm, 0.5 µm, 0.6 µm, 0.7 µm, 0.8 µm, 0.9 µm, 1.0 µm, 2 µm, 3 µm and so on, preferably 0.5-3 µm.

The particle diameter of the oxide solid electrolyte in the ternary positive piece according to the present disclosure is within the above range, and the oxide solid electrolyte is dispersed in the cathode active material layer, such an arrangement can significantly improve the safety performance and capacity of the lithium battery obtained from the ternary positive piece; when the particle diameter of the oxide solid electrolyte is less than 0.1 µm, the particle diameter of the oxide solid electrolyte is too small, the interface resistance becomes large, such that the ion transport is hindered, the interfacial impedance is increased, and the energy density of the battery is decreased; when the particle diameter of the oxide solid electrolyte is greater than 10 µm, the particle diameter is too large, its effect of isolating the contact between the anode particles is not significant, such that the safety performance of the lithium battery is not obviously improved.

Preferably, the content by mass of the oxide solid electrolyte is 0.1-10%, such as 0.5%, 1%, 2%, 3%, 4%, 5%, 6%, 7%, 8%, or 9% and so on, preferably 1-5%, based on the sum 100% of the mass of the anode active material and the oxide solid electrolyte in the anode active material layer.

When the added amount of a oxide solid electrolyte in the ternary positive piece of the present disclosure is within the aforementioned scope, it is conducive to improving the safety performance and capacity of the produced lithium battery; when the content of said oxide solid electrolyte is less than 0.1%, the doped amount of said oxide solid electrolyte blended is too small, the heat absorption and heat insulation effect of the solid electrolyte is not obvious, the safety performance is not significantly improved; when the content of said oxide solid electrolyte is more than 10%, the doped amount of the oxide solid electrolyte is too large, the percentage of the anode active materials is reduced, thereby decreasing the energy density of the battery.

Preferably, the oxide solid electrolyte comprises at least one selected from the group consisting of a NASICON structure, a perovskite structure, an inverse perovskite structure, a LISICON structure and a garnet structure.

Preferably, the NASICON structure is at least one selected from the group consisting of Li₁₊ₓAlₓGe₂₋ₓ(PO₄)₃ (LAGP) , isomorphic heteroatom-doped compounds of Li₁₊ₓAlₓGe₂₋ₓ(PO₄)₃, Li_{1+y}Al_{y}Ti_{2-y}(PO₄)₃ (LATP) , and isomorphic heteroatom-doped compounds of Li_{1+y}Al_{y}Ti_{2-y}(PO₄)₃; preferably Li_{1+y}Al_{y}Ti_{2-y}(PO₄)₃; wherein x is selected from a range of 0.1-0.4, for example 0.15, 0.2, 0.25, 0.3 or 0.35; and y is selected from a range of 0.1-0.4, such as 0.15, 0.2, 0.25, 0.3 or 0.35 and so on.

Preferably, the perovskite structure is at least one selected from the group consisting of Li_{3z}La_{⅔-z}TiO₃ (LLTO) , isomorphic heteroatom-doped compounds of Li_{3z}La_{⅔-z}TiO₃, Li_{⅜}Sr_{7/16}Ta_{¾}Hf_{¼}O₃ ( LSTH ) , isomorphic heteroatom-doped compounds of Li_{⅜}Sr_{7/16}Ta_{¾}Hf_{¼}O₃, Li_{2a-b}Sr₁₋ₐTa_{b}Zr_{1-b}O₃ (LSTZ) , and isomorphic heteroatom-doped compounds of Li_{2a-b}Sr₁₋ₐTa_{b}Zr_{1-b}O₃; where z is selected from a range of 0.06-0.14, for example, 0.07, 0.08, 0.09, 0.1, 0.11, 0.12 or 0.13 and so on; a is selected from 0.75×b, b is selected from a range of 0.25-1, such as 0.3, 0.35, 0.4, 0.45, 0.5, 0.55, 0.6, 0.65, 0.7, 0.75, 0.8, 0.85, 0.9 or 0.95.

Preferably, the inverse perovskite structure is at least one selected from the group consisting of Li₃₋₂ₓMₓHalO, isomorphic heteroatom-doped compounds of Li₃₋₂ₓMₓHalO, Li₃OCl, and isomorphic heteroatom-doped compounds of Li₃OCl; wherein Hal comprises Cl and/or I, and M is any one of Mg²⁺, Ca²⁺, Sr²⁺, or Ba²⁺, or a combination of at least two thereof.

Preferably, the LISICON structure is at least one selected from the group consisting of Li_{4-c}Si_{1-c}P_{c}O₄, isomorphic heteroatom-doped compounds of Li_{4-c}Si_{1-c}P_{c}O₄, Li₁₄ZnGe₄O₁₆(LZGO) and isomorphic heteroatom-doped compounds of Li₁₄ZnGe₄O₁₆; wherein c is selected from a range of 0-1, such as 0.1, 0.2, 0.3, 0.4, 0.5, 0.6, 0.7, 0.8 or 0.9 and so on.

Preferably, the garnet structure is selected from Li_{7-d}La₃Zr_{2-d}O₁₂ (LLZO) and/or isomorphic heteroatom-doped compounds of Li_{7-d}La₃Zr_{2-d}O₁₂, wherein d is selected from a range of 0.1-0.6, such as 0.2, 0.3 or 0.4 and so on.

Preferably, the ternary positive piece has an area capacity larger than or equal to 4mAh/cm², such as 5mAh/cm², 6mAh/cm², 7mAh/cm², 8mAh/cm², 9mAh/cm² or 10mAh/cm² and so on.

Preferably, the anode active material in said anode active material layer is selected from a high nickel ternary material.

Preferably, the high nickel ternary material comprises lithium nickel cobalt manganate and/or lithium nickel cobalt aluminate.

Preferably, the lithium nickel cobalt manganate is represented by the molecular formula LiNiₓCoMn_{1-x-y}O₂ and the lithium nickel cobalt aluminate is represented by the molecular formula LiNiₓCoAl_{1-x-y}O₂, wherein x ≥ 0.6, such as 0.65, 0.7, 0.8, 0.85, or 0.9 and so on.

In a second aspect, the present disclosure provides a method of preparing the ternary positive piece according to the first aspect comprising:
pre-mixing an anode active material with an oxide solid electrolyte to obtain a pre-mixed powder; and
adding a glue solution and a conductive agent into the pre-mixed powder and blending the mixture to form obtain an anode sizing agent; and
coating the anode sizing agent on a current collector to obtain a coated current collector, subjecting the coated current collector to drying so as to prepare the ternary positive piece.

Preferably, the anode active material is selected from a high nickel ternary material;

Preferably, a mass ratio of the anode active material to the oxide solid electrolyte is (90-99.9): (0.1-10), for example, 90:10, 92:8, 95:5, 98:2, 99:1 or 99.5:0.5 and so on.

Preferably, the pre-mixing process is carried out in a ball mill or a blender at a revolution rate of 30-50 r/min, such as 35 r/min, 40 r/min or 45 r/min and so on, and at a dispersion rotation speed of 300-3,000 r/min, such as 500 r/min, 800 r/min, 1,000 r/min, 1,200 r/min, 1,500 r/min, 1,800 r/min, 2,000 r/min, 2,200 r/min, 2,500 r/min or 2,800 r/min and so on, and the dispersion rotation speed is preferably within a range of 500-2,000 r/min.

In a third aspect, the present disclosure provides a lithium battery comprising the ternary positive piece according to the first aspect.

Preferably, the lithium battery comprises any one of a liquid lithium battery, a semi-solid lithium battery and an all-solid lithium battery.

Preferably, the liquid lithium battery comprises the ternary positive piece according to the first aspect, a negative piece and a liquid electrolyte

Preferably, the semi-solid lithium battery comprises the ternary positive piece according to the first aspect, a negative piece, and an electrolyte layer containing a liquid electrolyte material.

Preferably, the solid-state lithium battery comprises the ternary positive piece according to the first aspect, a negative piece and a solid electrolyte layer.

Preferably, the solid electrolyte in the solid electrolyte layer is at least one selected from the group consisting of a polymer solid electrolyte, an oxide solid electrolyte and a sulfide solid electrolyte.

In the last aspect, the present disclosure aims to provide a positive piece, a preparation method and a use thereof, in particular to provide a ternary positive piece for a lithium battery having both high safety and high capacity and a long cycle, a preparation method thereof, a method for improving safety performance of a lithium battery, the corresponding positive piece, and a lithium battery.

A use of the “a lithium battery having both high safety and high capacity and a long cycle” according to the present disclosure, the long cycle indicates that the capacity retention ratio of a lithium battery manufactured by using the negative piece can be 80% or more after the cycle life of 1,000 times of charging/discharging at the currents of 1C/1C; the high capacity indicates an area capacity larger than or equal to 4mAh/cm²; the high safety indicates that the battery can pass the piercing test and 180° C. hot box test, the lithium battery does not catch fire, explode and is smokeless in both of the piercing test and the 180° C. hot box test.

To achieve the above objects, the present disclosure uses the following technical solutions:

In a first aspect, the present disclosure provides a ternary positive piece for a lithium battery comprising a current collector and an anode material layer disposed on a surface of the current collector, the anode material layer comprising ternary anode active material particles, a conductive agent, a binder, and oxide solid electrolyte particles capable of conducting Lithium-ions;

the positive piece has an area capacity larger than or equal to 4 mAh/cm², the oxide solid electrolyte particles have a particle diameter D50 within a range of 0.1-3 µm.

In the present disclosure, the positive piece has an area capacity larger than or equal to 4 mAh/cm², such as 4 mAh/cm², 6 mAh/cm², 8 mAh/cm², 10 mAh/cm², 12 mAh/cm², or 15 mAh/cm² and so on.

In the positive piece of the present disclosure, the ternary anode active material particles are used as the main active component; in order to obtain a ternary anode having a high area capacity, the existing art generally uses a high nickel ternary anode material with a high specific capacity or increases the thickness of the pole piece. On the one hand, the high temperature stability of the ternary anode material is poor, and the higher is the content of nickel in the ternary anode material, the poorer is the thermal stability; on the other hand, an increased thickness of the electrode prolongs transport path of electrons and Lithium-ions, increases battery resistance and Joule heat during the charging and discharging process. The energy stored per area of the anode material is also high in regard to the ternary anode material having a high area capacity, the higher is the releasable energy per area of the anode material in case of short circuiting or overheating, thus causing serious safety hazard. Therefore, it is necessary to propose a solution for providing a lithium battery having both high safety and high capacity.

The present disclosure discloses a method of adding the positive piece with an oxide solid electrolyte having a particle diameter D50 of 0.1-3 µm, in combination with a conductive agent and a binder, thereby forming an positive piece having an area capacity larger than or equal to 4 mAh/cm², the present disclosure improves the thermal stability of the negative piece and guarantees the safety performance of the battery, without affecting the high capacity and long cycle performance of the battery. The technical principle is as follows: firstly, the oxide solid electrolyte particles have a certain ion transport capacity, and can also effectively obstruct the contact between the ternary cathode active material particles, such that the thermal stability is improved under the premise of ensuring the transport of ions; secondly, the oxide solid electrolyte per se has an endothermic effect and can absorb a part of the heat, alleviate overheating of the anode; thirdly, the oxide solid electrolyte has high chemical stability, and does not alter the current mainstream manufacturing processes of the positive piece, the diaphrams and the battery, and has the advantage of high stability and low cost, it is suitable for large scale applications. Since the oxide solid electrolyte particles per se have a certain ionic conduction capacity, the introduction of the oxide solid electrolyte does not significantly hinder the ion transport capacity in the anode when the content is within the content range of the solid electrolyte according to the present disclosure; moreover, the endothermic effect of the oxide solid electrolyte lowers the average temperature of the anode active material during the charging and discharging process, reduces the side reactions of the ternary cathode active material at a high temperature, thus contributing to the guarantee of long cycle performance of the battery.

In the present disclosure, the oxide solid electrolyte particles have a particle diameter D50 within a range of 0.1-3 µm, such as 0.1 µm, 0.5 µm, 1 µm, 2 µm, 2.5 µm, or 3 µm and so on. If the particle diameter of the oxide solid electrolyte particles is too small, their interface resistance will be significantly increased, thereby hindering the ion transport and affecting the exertion of the anode capacity, reducing the energy density of a battery prepared therefrom; if the particle diameter is too large, the effect of obstructing contact between anode particles with the oxide solid electrolyte is not obvious, such that the safety performance of a battery is not significantly improved.

The technical objects and favorable effects of the present disclosure can be desirably realized and attained by the preferred embodiments hereinafter, which shall not be regarded as limitation to the technical solution provided by the present disclosure.

Preferably, the oxide solid electrolyte particles have a particle diameter D50 within a range of 0.5-2 µm.

Preferably, the content of the ternary anode active material particles is 80-98%, based on a total mass 100% of the ternary anode active material particles, the conductive agent, the binder and the oxide solid electrolyte particles.

Preferably, the content of the oxide solid electrolyte is within a range of 0.1-10%, such as 0.1%, 0.3%, 0.5%, 0.8%, 1%, 1.5%, 2%, 2.5%, 3%, 4%, 5%, 6%, 7%, 7.5%, 8%, 8.5%, 9% or 10% and so on, based on the total mass 100% of the ternary anode active material particles, the conductive agent, the binder and the oxide solid electrolyte particles; if the content of the oxide solid electrolyte is less than 0.1%, it cannot effectively block contact between the ternary anode active material particles, the improvement of safety performance of a battery is not obvious; if the content of the oxide solid electrolyte is more than 10%, it influences ion transport, reduces Lithium-ions conductivity, affects exertion of the battery capacity, reduces energy density and degrades cycle performance of the battery; as a result, the content of the oxide solid electrolyte is preferably within a range of 0.1-10%, more preferably 1-5%.

Preferably, the content of the conductive agent is 0.1-8%, such as 0.1%, 0.5%, 1%, 1.5%, 2%, 3%, 3.5%, 4%, 5%, 6%, 7% or 8% and so on, based on the total mass 100% of the ternary anode active material particles, the conductive agent, the binder and the oxide solid electrolyte particles.

Preferably, the content of the binder is within a range of 0.1-10%, such as 0.1%, 0.8%, 1.2%, 3%, 5%, 6%, 7%, 8% or 10% and so on, based on the total mass 100% of the ternary anode active material particles, the conductive agent, the binder and the oxide solid electrolyte particles.

Preferably, the oxide solid electrolyte particles comprise any one of the following compounds or a combination of at least two thereof: Li₁₊ₓ₁Alₓ₁Ge₂₋ₓ₁(PO₄)₃ (LAGP) of the NASICON structure or isomorphic heteroatom-doped compounds thereof; Li₁₊ₓ₂Alₓ₂Ti₂₋ₓ₂(PO₄)₃ (LATP) of the NASICON structure or isomorphic heteroatom-doped compounds thereof; Li₃ₓ₃La_{⅔-x3}TiO₃ (LLTO) of the perovskite structure or isomorphic heteroatom-doped compounds thereof; Li_{⅜}Sr_{7/16}Ta_{¾}Hf_{¼}O₃(LSTH) of the perovskite structure or isomorphic heteroatom-doped compounds thereof; Li_{2x4-y1}Sr₁₋ₓ₄Ta_{y1}Zr_{1-y1}O₃ (LSTZ) of the perovskite structure or isomorphic heteroatom-doped compounds thereof; Li₃₋₂ₓ₅Mₓ₅HalO and Li₃OCl of an inverse perovskite structure or isomorphic heteroatom-doped compounds thereof; Li₄₋ₓ₆Si₁₋ₓ₆Pₓ₆O₄ of the LISICON structure or isomorphic heteroatom-doped compounds thereof; Li₁₄ZnGe₄O₁₆ (LZGO) of the LISICON structure or isomorphic heteroatom-doped compounds thereof; Li₇₋ₓ₇La₃Zr₂₋ₓ₇O₁₂ (LLZO) of the garnet structure or isomorphic heteroatom-doped compounds thereof; wherein 0<x1≤0.75, 0<x2≤0.5, 0.06≤x3≤0.14, 0.25≤y1≤1, x4=0.75y1, 0≤x5≤0.01, 0.5≤x6≤0.6; 0≤x7<1; wherein M includes any one of Mg²⁺, Ca²⁺, Sr²⁺ or Ba²⁺ or a combination of at least two thereof, and Hal is element C1 or I.

Preferably, the oxide solid electrolyte particles comprise Li₁₊ₓ₂Alₓ₂Ti₂₋ₓ₂(PO₄)₃ and/or Li₇₋ₓ₇La₃Zr₂₋ₓ₇O₁₂, preferably Li₁₊ₓ₂Alₓ₂Ti₂₋ₓ₂(PO₄)₃.

The ternary anode active material particles comprise lithium nickel cobalt manganite (NCM) and/or lithium nickel cobalt aluminate (NCA).

Preferably, the ternary anode active material particles are represented by the molecular formula LiNiₓCo_{y}M_{1-x-y}O₂, M is at least one of Mn or Al, and x is larger or equal to 0.6, such as 0.6, 0.65, 0.7, 0.8 or 0.88 and so on; the ternary anode active material of the preferred embodiment is a high nickel ternary anode material having a high specific energy and a poor thermal stability; the present disclosure makes improvement by using an oxide solid electrolyte in combination with a conductive agent and a binder, can solve the problem of safety performance and fully exploit its advantage of high energy density.

Preferably, the conductive agent includes any one of Super-P, KS-6, carbon black, carbon nanofiber, CNT, acetylene black or grapheme, or a combination of at least two thereof. The typical, but not limiting, examples of the combinations comprise: the combination of Super-P and KS-6, the combination of Super-P and carbon black, the combination of Super-P and nanocarbon fibres, the combination of carbon black and CNT, the combination of KS-6, carbon black and CNT; preferably the combination of carbon nanotubes and Super-P.

Preferably, the binder comprises any one of polyvinylidene fluoride (PVDF), polyvinylidene fluoride-hexafluoropropylene (PVDF-HFP), polyethylene oxide (PEO), polytetrafluoroethylene (PTFE) or a combination of at least two thereof. The typical, but not limiting, examples of the combinations comprise: the combination of PVDF and PEO, the combination of PVDF and PTFE, the combination of PVDF and PVDF-HFP, and the likes.

Preferably, a ratio of the particle diameter D50 of the ternary anode active material particles to the particle diameter D50 of the oxide solid electrolyte particles is larger than or equal to 5, such as 5, 6, 8, 10, 12, 13, or 15 and so on. If the particle diameters of the ternary anode active material particles and the oxide solid electrolyte particles are close to each other, due to the restraint of a content of the solid electrolyte, the content of the solid electrolyte under the condition of particle diameters is insufficient to block contact between the ternary anode active material particles, resulting in poor safety performance of the material.

In a second aspect, the present disclosure provides a method of preparing the positive piece according to the first aspect comprising:
S1: pre-mixing anode active material particles and oxide solid electrolyte particles to obtain a premixed material, wherein the anode active material particles comprising ternary anode active material particles;
S2: adding a glue solution as a binder to the premixed material to obtain a primary sizing agent;
S3: adding a conductive agent to the primary sizing agent and blending the mixture to obtain a secondary sizing agent;
S4: coating the secondary sizing agent on a current collector to obtain a coated current collector, controlling an area capacity of the pole piece to be larger than or equal to 4mAh/cm², subjecting the coated current collector to baking and rolling, so as to prepare the positive piece.

In the method of the present disclosure, step S2 and step S3 can be added independently, either once or stepwise.

Preferably, the pre-mixing is a vacuum pre-mixing or is performed under a condition having a dew point ≤ -30° C. (e.g., -30° C., -35° C., -40° C., -45° C., or -50° C.). In the preferred technical solution, the anode active material particles and the oxide solid electrolyte particles are first vacuum pre-mixed or are pre-mixed under a condition having a dew point ≤ -30° C., in order to uniformly disperse the two substances and ensure the stability of the ternary anode active material and oxide solid electrolyte. For example, Li₇₋ₓ₇La₃Zr₂₋ₓ₇O₁₂ (0≤x7<1) is prone to carry out side reactions with water under the condition having a dew point ≥ 0° C., resulting in the destruction of the product structure and the deterioration of the performance.

Preferably, the pre-mixing and blending process is carried out in a ball mill or a blender.

Preferably, the pre-mixing and blending process is performed by using a self-rotating and revolving blender having a revolution speed ≥ 20 rpm, such as 20 rpm, 30 rpm, 40 rpm, 50 rpm, 60 rpm, 70 rpm, 80 rpm, 85 rpm or 100 rpm and so on, independently preferably 30-90 rpm, and an autorotation speed ≥ 200 rpm, such as 200 rpm, 300 rpm, 400 rpm, 600 rpm, 800 rpm, 1,000 rpm, 1,200 rpm, 1,300 rpm, 1,500 rpm, 1,750 rpm, 2,000 rpm, 2,200 rpm, 2,500 rpm or 3,000 rpm and so on, independently preferably 500-2,000 rpm.

Preferably, the pre-mixing is performed for 0.5-4 h, such as 0.5 h, 1 h, 1.5 h, 2 h, 3 h or 4 h and so on, more preferably 1-2 h.

Preferably, the dew point is ≤ -45° C., further preferably ≤ -60° C.

In order to ensure desired dispersity and structural stability of the oxide solid electrolyte to effectively obstruct contact between the ternary anode active material particles, and enhance thermal stability of the positive piece, the preparation method is preferably performed in accordance with the above-mentioned conditions of revolution speed, autorotation speed and dew point.

As a further preferred embodiment of the method according to the present disclosure, the method comprises the following steps:
S1: vacuum premixing a ternary anode active material particles with oxide solid electrolyte particles in a self-rotating and revolving blender, wherein the revolution speed is within a range of 30-90 rpm, the autorotation speed is within a range of 500-2,000 rpm, the premixing time is 0.5-4h, so as to obtain a uniformly blended pre-mixed material;
S2: gradually adding a uniformly mixed glue solution to the uniformly blended pre-mixed material of S1, with a rotation speed of 30-90 rpm and an autorotation speed of 500-2,000 rpm, so as to obtain a uniformly mixed sizing agent;
S3: stepwise adding a conductive agent to the uniformly mixed sizing agent of S2, with a revolution speed of 30-90 rpm and an autorotation speed of 500-2,000 rpm, so as to finally obtain a uniformly mixed ternary anode sizing agent;
S4: coating the mixed ternary anode sizing agent of S3 on a current collector to obtain a coated current collector, controlling an area capacity of the pole piece to be larger than or equal to 4mAh/cm², subjecting the coated current collector to baking, rolling and die cutting, so as to prepare the ternary anode electrode piece having high safety and high capacity.

In a third aspect, the present disclosure provides a method for improving the safety performance of a lithium battery comprising adding a oxide solid electrolyte particles having a particle diameter D50 within a range of 0.1-3 pm and dispersing the oxide solid electrolyte particles between an anode active material particles during the preparation process of an positive piece having an area capacity > 4 mAh/cm².

The present disclosure also provides an positive piece obtained with the method of the third aspect.

In a fourth aspect, the present disclosure provides a lithium battery comprising the positive piece according to the first aspect.

Preferably, the lithium battery comprises a liquid lithium battery or a semi-solid lithium battery.

Preferably, the liquid lithium battery comprises the positive piece according to the first aspect, a negative piece and a liquid electrolyte (also referred to as electrolyte).

Preferably, the semi-solid lithium battery comprises the positive piece according to the first aspect, a negative piece and an electrolyte layer containing the liquid electrolyte.

Relative to the exsiting art, the present disclosure produces the following favorable effects:
(1) the positive piece for a lithium battery of the present disclosure is doped and mixed with a Lithium ion-rich compound that can pull away Lithium-ions under extreme conditions in use, the battery assembled with the positive piece can pull away Lithium-ions under the extreme conditions such as overcharge and overheating, fill in lithium vacancies in the anode material, stabilize the crystal lattice structure of the anode material, improve the safety performance of the battery manufactured therefrom, maintain lithium balance in the positive electrode, thereby enhancing the overall thermal stability of the positive electrode, and improving the safety performance of the battery under extreme conditions;
(2) the positive piece for a lithium battery according to the present disclosure is doped and mixed with the a lithium-rich compound, which can improve cycle performance of the positive piece under the high area capacity;
(3) the anode active material layer of the ternary positive piece of the present disclosure is dispersed with an oxide solid electrolyte in the form of porous spherical particles; which can remarkably improve the safety performance of a lithium battery obtained therefrom; the obtained lithium battery can pass a piercing test, a test of heating at 180° C. for 2 h, and a test of 50% deformation compression;
(4) the specific capacity of the lithium battery obtained from the ternary positive piece according to the present disclosure can reach 300 Wh/kg or more;
(5) the present disclosure discloses a method of adding an oxide solid electrolyte having a particle diameter D50 of 0.1-3 µm into the positive piece, in combination with a conductive agent and a binder, thereby forming an positive piece having an area capacity larger than or equal to 4 mAh/cm², the present disclosure significantly improves safety performance of a battery on the basis of ensuring high capacity and the pole piece and the long cycle performance of the battery. The technical principle is as follows: firstly, the oxide solid electrolyte particles have a certain ion transport capacity, and can also effectively obstruct the contact between the ternary cathode active material particles, such that the thermal stability of the anode is improved under the premise of ensuring the transport of ions; secondly, the oxide solid electrolyte per se has a certain thermal capacity, and can absorb a part of the heat generated by the anode, alleviate overheating of the anode; thirdly, the oxide solid electrolyte is directly doped and mixed into the anode material, and will not affect the electrochemical performance of the anode active particles per se, in contrast to the modification method of coating the anode active material particles with the oxide electrolyte, the coating layer will hinder transport of ions and electrons in the anode active material particles, and affect the overall performance of the battery; in addition, the oxide solid electrolyte has high chemical stability, can be directly doped and mixed in the anode active material before the preparation of the pole piece; the positive piece of the present disclosure is compatible with the currently mainstream preparation process of the positive piece of the Lithium-ions battery, does not affect the manufacturing process of the anode and the battery core, and has low costs during the large scale production, thus it is suitable for the large scale application.

Given that the lithium battery assembled from the positive piece according to the present disclosure has the characteristics of high capacity, high safety and long cycle, the battery can pass the piercing test smoothly. The preferred embodiment of the positive piece according to the present disclosure can also realize high specific energy of the battery (generally, the specific energy per mass of the battery is larger than or equal to 260 Wh/Kg) while achieving the above-mentioned effects.

### BRIEF DESCRIPTION OF THE DRAWINGS

FIG. 1 is a test curve of the cycle performance of the batteries of Comparative Example 1 and Examples 1, 3 and 5 at a high area capacity when the energy density of the 15 Ah cells reaches 300 Wh/Kg;

FIG. 2 is a view illustrating a high-energy piercing test of the cell made from a high-nickel ternary material in Comparative Example 1, and a high-energy piercing test of the cell made from a high-nickel ternary positive piece in Example 3 doped and mixed with the lithium-rich solid electrolyte Li₇La₃Zr₂O₁₂;

FIG. 3 illustrates a schematic view of the structure of the ternary positive piece of the present disclosure;

FIG. 4 is a schematic view showing the structure of a lithium battery assembled from the ternary positive piece according to the present disclosure;

1-ternary positive piece; 10-aluminum foil; 11-anode active material; 12-oxide solid electrolyte; 2-negative piece; 20-copper foil; 21-cathode active material; 3-solid electrolyte, liquid electrolyte or semi-solid electrolyte, wherein the liquid lithium-ion battery further comprises a diaphram;

FIG. 5 is a schematic view showing an internal structure of an anode material layer in the ternary electrode piece doped and mixed with oxide solid electrolyte of the present disclosure, wherein 1-oxide solid electrolyte; 2-ternary anode active material; 3-conductive agent;

FIG. 6 illustrates a picture of the battery of Comparative Example 4 after the piercing test;

FIG. 7 illustrates a picture of the battery of Example 38 after the piercing test.

### DETAILED DESCRIPTION

The technical solutions of the present disclosure will be clearly and completely described below with reference to the examples of the present disclosure. Obviously, the described examples are only part of the embodiments of the invention, instead of covering all the embodiments. Based on the embodiments of the present disclosure, all other embodiments obtained by the ordinary skilled person in the art without paying a creative labor fall into the protection scope of the present disclosure.

The technical solution of the present disclosure is further described by using the specific embodiments below. It should be understood by those skilled in the art that the examples merely serve to facilitate comprehension of the present disclosure, shall not be regarded as imposing the specific limitation to the present disclosure.

### Comparative Example 1

In the Comparative Example 1, a lithium-rich compound was not mixed in the positive piece; the anode active material in the positive piece was LiNi_{0.83}Co_{0.12}Mn_{0.05}O₂(Ni83), the binder was PVDF, and the conductive agent was CNT; a mass ratio of the anode active material, the binder and the conductive agent was 95:2:3, the preparation method of the positive piece was composed of the following steps:

A glue solution was uniformly mixed with Ni83, the conductive agent was added to form an anode sizing agent, which was then coated on an aluminum foil, and then subjected to baking, cold pressing and tabletting to prepare an positive piece, the produced positive piece had an area capacity of 5.4 mAh/cm².

The well-designed negative piece (with an active material SiC) was assembled and welded with ceramic diaphrams each having a thickness of 15 µm and a porosity of 50%, and subjected to hi-pot test and packaging, and then subjected to baking, the injected lithium salt was LiPF₆, the solvent was a mixed solvent of ethylene carbonate, dimethyl carbonate and fluoroethylene carbonate, the additive was VC electrolyte; the encapsulation, formation and capacity separation process was performed after the injection, the battery was fabricated.

### Example 1

In the Example, a lithium-rich manganese-based solid solution was doped and mixed in the positive piece; the lithium-rich manganese-based solid solution was 0.5Li₂MnO₃ · 0.5LiMn_{0.54}Ni_{0.13}Co_{0.13}O₂, the mass ratio of the anode active material to the lithium-rich compound was 94:6; the particle diameter of the lithium-rich compound was 500 nm; the anode active material in the positive piece was Ni83, the binder was PVDF, and the conductive agent was CNT; and the method of preparing the positive piece comprising the following steps:
the anode active material was premixed with the lithium-rich compound nanoparticles for 1 h in advance at a revolution speed of 40 r/min and a dispersion rotation speed of 500 r/min to obtain a premixed powder;
a glue solution was added to the premixed powder according to the mass ratio of premixed powder: binder: conductive agent of 95:2:3, the materials were uniformed mixed and then added with the conductive agent to prepare an anode sizing agent; which was then coated on an aluminum foil, and then subjected to baking, cold pressing and tabletting to prepare an positive piece, the positive piece had an area capacity of 5.4 mAh/cm².

The well-designed negative piece (with an active material SiC) was assembled and welded with ceramic diaphrams each having a thickness of 15 µm and a porosity of 50%, and subjected to hi-pot test and packaging, and then subjected to baking, the injected lithium salt was LiPF₆, the solvent was a mixed solvent of ethylene carbonate, dimethyl carbonate and fluoroethylene carbonate, the additive was VC electrolyte; the encapsulation, formation and capacity separation process was performed after the injection, the battery was fabricated.

### Example 2

This Example differed from Example 1 in that the mass ratio of the anode active material to the lithium-rich manganese-based solid solution was 90:10; the lithium-rich manganese-based solid solution was 0.37Li₂MnO₃·0.63LiNi_{0.13}Co_{0.13}Mn_{0.54}O₂, the particle diameter of the lithium-rich manganese-based solid solution was 2 µm, the other parameters and conditions were completely identical to those in Example 1.

### Example 3

This Example differed from Example 1 in that the mass ratio of the anode active material to the lithium-rich solid electrolyte was 99.5:0.5, the particle diameter of the particles of the lithium-rich solid electrolyte was 200 nm, and the lithium-rich solid electrolyte was Li₇La₃ZrO₂, the other parameters and conditions were completely identical to those in Example 1.

### Example 4

This Example differed from Example 1 in that the mass ratio of the anode active material to the lithium-rich solid electrolyte was 92:8, the particle diameter of the lithium-rich solid electrolyte was 2 µm, and the lithium-rich solid electrolyte was L1_{6.75}La₃Zr_{1.75}Ta_{0.25}O₁₂, with other parameters and conditions were identical to those in Example 1.

### Example 5

This Example differed from Example 1 in that the mass ratio of the anode active material to the lithium-rich delithiated compound was 99.5:0.5, the particle diameter of the lithium-rich delithiated compound was 200 nm, the lithium-rich delithiated compound was Li_{1.4}SiO_{0.9}, the other parameters and conditions were completely identical to those in Example 1.

### Example 6

This Example differed from Example 1 in that the anode active material was LiNi_{0.8}Co_{0.1}Al_{0.1}O₂, the lithium-rich delithiated compound was Li_{2.1}SiO, the mass ratio of the anode active material to the lithium-rich delithiated compound was 95:5, the particle diameter of the lithium-rich delithiated compound was 1 µm; the other parameters and conditions were completely identical to those in Example 1.

### Example 7

This Example differed from Example 1 in that the mass ratio of the anode active material to the lithium-rich solid electrolyte was 94:6, the particle diameter of the lithium-rich solid electrolyte was 500 nm, the lithium-rich solid electrolyte was Li₇La₃Zr₂O₁₂, the other parameters and conditions were completely identical to those in Example 1.

### Example 8

This Example differed from Example 1 in that the mass ratio of the anode active material to the lithium-rich delithiated compound was 94:6; the particle diameter of the lithium-rich delithiated compound was 500 nm; the lithium-rich delithiated compound was Li_{1.4}SiO_{0.9}; the other parameters and conditions were completely identical to those in Example 1.

### Example 9

This Example differed from Example 1 in that the mass ratio of the anode active material to the lithium-rich manganese-based solid solution was 94:6; the particle diameter of the lithium-rich lithium manganese-based solid solution was 10 µm; the lithium-rich manganese-based solid solution was 0.5Li₂MnO₃ 0.5LiMn_{0.54}Ni_{0.13}Co_{0.13}O₂, the other parameters and conditions were completely identical to those in Example 1.

### Example 10

This Example differed from Example 1 in that the mass ratio of the anode active material to the lithium-rich manganese-based solid solution was 94:6; the particle diameter of the lithium-rich lithium manganese-based solid solution was 100 nm; the lithium-rich manganese-based solid solution was 0.5Li₂MnO₃ 0.5LiMn_{0.54}Ni_{0.13}Co_{0.13}O₂; the other parameters and conditions were completely identical to those in Example 1.

### Example 11

This Example differed from Example 1 in that the mass ratio of the anode active material to the lithium-rich manganese-based solid solution was 99:1; the particle diameter of the lithium-rich manganese-based solid solution was 500 nm; the lithium-rich manganese-based solid solution was 0.5Li₂MnO₃ 0.5LiMn_{0.54}Ni_{0.13}Co_{0.13}O₂, the other parameters and conditions were completely identical to those in Example 1.

### Example 12

This Example differed from Example 1 in that the mass ratio of the anode active material to the lithium-rich manganese-based solid solution was 95:5; the particle diameter of the lithium-rich manganese-based solid solution was 500 nm; the lithium-rich manganese-based solid solution was 0.5Li₂MnO₃ 0.5LiMn_{0.54}Ni₀.₁₃Co_{0.13}O₂; the other parameters and conditions were completely identical to those in Example 1.

### Example 13

This Example differed from Example 1 in that the mass ratio of the anode active material to the lithium-rich delithiated compound was 80:20; the particle diameter of the lithium-rich delithiated compound was 500 nm; the lithium-rich delithiated compound was Li_{1.6}SiO_{1.1}, the other parameters and conditions were completely identical to those in Example 1.

### Example 14

This Example differed from Example 5 in that the mass ratio of the anode active material to the lithium-rich delithiated compound was 99.5:0.5, the particle diameter of the lithium-rich delithiated compound is 200 nm, the lithium-rich delithiated compound was Li_{2.1}SiO, the other parameters and conditions were completely identical to those in Example 5.

Tests were conducted on batteries assembled from positive pieces obtained from Comparative Example 1 and Examples 1-14;

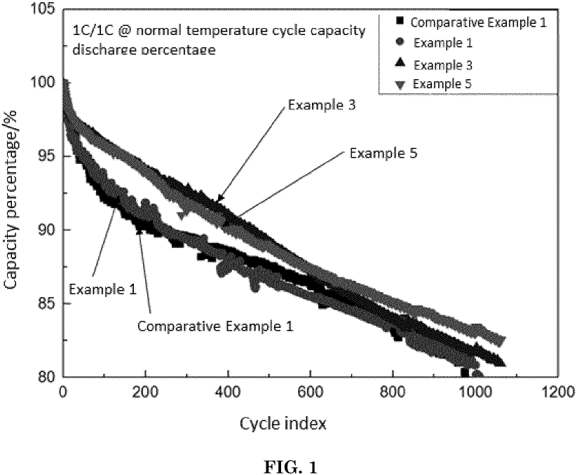

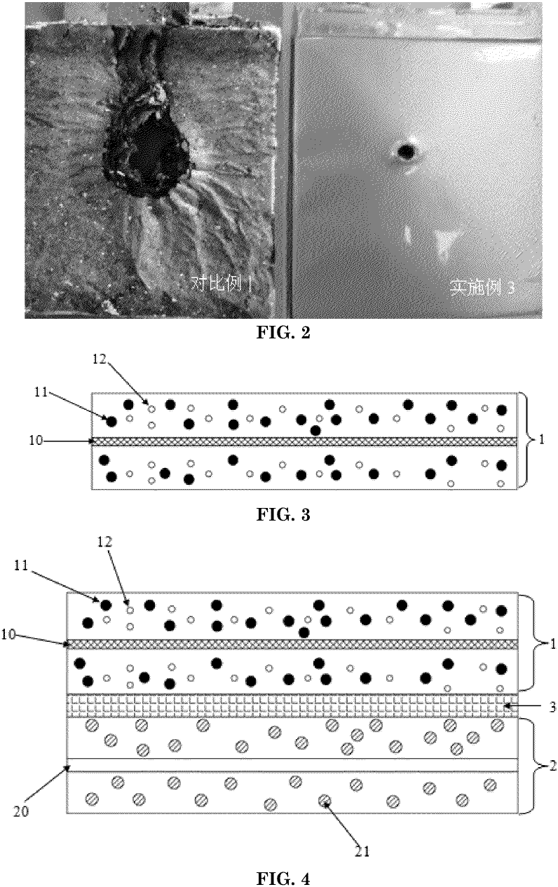

1. Cycle test: the energy density of 15 Ah batteries of Comparative Example 1 and Examples 1, 3 and 5 at high area capacity reached 300 Wh/Kg, the batteries were subjected to the cycle performance test, and the test continued when the cell discharge capacity percentage was larger than 80%, otherwise the test was stopped; the test results were shown in FIG. 1; it can be seen from FIG. 1 that the batteries with a high area capacity had a cell discharge capacity percentage larger than 80% after 1,000 cycles of the charging and discharging at the current of 1C, the lithium-rich compound was added into the positive piece, the cycle performance of the batteries were slightly improved.

2. Piercing test: 15 Ah batteries had an energy density larger than or equal to 300 Wh/Kg, test conditions comprised: a diameter φ of the needle was within a range of 3-8 mm, piercing rate was 25-80 mm/s; the battery core was pierced vertically, the needle was retained in the battery for 1 h, the battery was denoted as passing the test if there was “no fire, no explosion”, otherwise the test result was failed.

TABLE 1

| Scheme | Energy density Wh/Kg | Result | Voltage before the test /V | Voltage after the test /V | Maximum temperature of battery surface /°C |
|---|---|---|---|---|---|
| Comparative Example 1 | 304 | Failed | 4.176 | 0 | 426.3 |
| Example 1 | 303 | Passing | 4.180 | 3.955 | 52.8 |
| Example 2 | 302 | Passing | 4.178 | 3.838 | 50.9 |
| Example 3 | 302 | Passing | 4.175 | 4.121 | 38.8 |
| Example 4 | 301 | Passing | 4.177 | 4.107 | 37.5 |
| Example 5 | 302 | Passing | 4.175 | 3.556 | 43.1 |
| Example 6 | 303 | Passing | 4.178 | 4.088 | 45.2 |
| Example 7 | 301 | Passing | 4.175 | 4.100 | 44.3 |
| Example 8 | 302 | Passing | 4.179 | 4.025 | 52.4 |
| Example 9 | 302 | Passing | 4.173 | 3.876 | 55.5 |
| Example 10 | 302 | Passing | 4.176 | 3.525 | 53.7 |
| Example 11 | 303 | Passing | 4.178 | 4.001 | 62.1 |
| Example 12 | 302 | Passing | 4.176 | 3.778 | 59.0 |
| Example 13 | 296 | Passing | 4.175 | 4.038 | 35.9 |
| Example 14 | 303 | Passing | 4.179 | 3.661 | 60.6 |

As can be seen from the above Table 1, the energy density of the battery comprising an anode added with the lithium-rich compound was larger than 300 Wh/Kg, the battery can pass the piercing test, and the change of surface temperature after the piercing test was not obvious; when the added amount of the lithium-rich compound was 20%, the energy density of the battery was reduced significantly; in contrast, the battery without adding the lithium-rich compound cannot pass the piercing test.

3: Thermal shock test: 15 Ah batteries had an energy density larger than or equal to 300 Wh/Kg, the batteries were subjected to heating at 190° C. for 2 h; the temperature rise rate was 5° C./min, the temperature was raised to 190° C. and preserve for 2 h, and then observed for 1 h; the battery was denoted as passing the test if there was “no fire, no explosion”, otherwise the test result was failed; the test results were shown in Table 2;

TABLE 2

| Scheme | Energy density Wh/Kg | Result | Voltage before the test /V |
|---|---|---|---|
| Comparative Example 1 | 304 | Failed | 4.176 |
| Example 1 | 302 | Passing | 4.180 |
| Example 2 | 301 | Passing | 4.178 |
| Example 3 | 303 | Passing | 4.175 |
| Example 4 | 302 | Passing | 4.177 |
| Example 5 | 302 | Passing | 4.175 |
| Example 6 | 302 | Passing | 4.178 |
| Example 7 | 301 | Passing | 4.176 |
| Example 8 | 301 | Passing | 4.168 |
| Example 9 | 302 | Passing | 4.171 |
| Example 10 | 301 | Passing | 4.158 |
| Example 11 | 303 | Passing | 4.163 |
| Example 12 | 302 | Passing | 4.152 |
| Example 13 | 294 | Passing | 4.177 |
| Example 14 | 302 | Passing | 4.168 |

As can be seen from Table 2 above, the energy density of the battery comprising an anode added with the lithium-rich compound was larger than 300 Wh/Kg, the battery can pass the thermal shock test at 190° C. for 2 h; the energy density of the battery was reduced significantly when the added amount of the lithium-rich compound was 20%; in contrast, the battery cell without adding the lithium-rich compound cannot pass the thermal shock test at 190° C.

The present disclosure can significantly improve the safety performance of high energy density batteries by doping and mixing a lithium-rich compound into a high nickel ternary positive piece. The energy density of the batteries of Comparative Example 1 and Examples 1, 3 and 5 can reach 300 Wh/Kg; the batteries of Examples 1, 3 and 5 added with different lithium-rich compound can pass the piercing test, the change of surface temperature of the batteries was not obvious; the batteries passed the thermal shock test at 190° C. for 2 h, the reasons mainly resides in that the lithium-rich compound can pull away Lithium-ions under the extreme conditions, thereby filling in lithium vacancies in the anode material, stabilizing the crystal lattice structure of the anode material, stabilizing the content of lithium in the anode, decreasing the oxidation state of the anode under the extreme conditions, and enhancing the safety performance of the battery prepared therefrom under the extreme conditions;

Examples 9, 10 and 1 were compared to illustrate the influence of adding different particle diameters on the safety performance of the batteries, the desirable effect of improving safety performance of the battery cannot be produced if the particle diameter of the lithium-rich compound doped into the anode was too small or too large; when the particle diameter of the lithium-rich compound was too small, the interface resistance was increased, such that the ion transport was blocked; when the particle diameter was too large, its effect of separating the anode particles was not obvious, thus the safety performance of the battery was not significantly improved.

Examples 5 and 13 were compared to demonstrate an influence of the added amount of the lithium-rich compound on the safety performance of the battery; if the added amount was too small, the improvement of the safety performance was not obvious; if the added amount was too large, the safety performance of battery can be improved, but the reduced amount of active material particles in the positive piece will slightly lower the energy density of the battery, the energy density of the battery of Example 13 was lowered to 294 Wh/Kg.

As can be seen from the comparison result of Examples 1, 7 and 8, under the condition that the mixed amounts were the same, the battery prepared by doping and mixing with lithium-rich solid electrolyte showed superior safety performance, the maximum temperature of the battery surface is the lowest during a process of subjecting to the piercing test.

FIG. 3 illustrated a schematic view of the structure of the ternary positive piece of the present disclosure, as shown in FIG. 3, the ternary positive piece 1 included a current collector 10 (e.g., an aluminum foil), and an anode active material layer disposed on a surface of the current collector, wherein the anode active material layer comprising an anode active material 11 and an oxide solid electrolyte 12.

FIG. 4 was a schematic view showing the structure of a lithium battery assembled from the ternary positive piece according to the present disclosure, as can be seen from FIG. 4, the lithium battery comprising a ternary positive piece 1, a negative piece 2, and a solid, liquid or semi-solid electrolyte 3 disposed therebetween; the negative piece 2 comprising a current collector 20 and a cathode active material layer disposed on a surface of the current collector, the cathode active material layer containing a cathode active material 21.

### Comparative Example 2

In the Comparative Example 2, the current collector in the ternary positive piece was aluminum foil, the anode active material was Ni₈₃CLiNi_{0.83}Co_{0.11}Mn_{0.06}O₂), the oxide solid electrolyte was LATP (Li_{1.4}Al_{0.4}Ti_{1.6}(PO₄)₃) with a solid spherical shape, the mass ratio of he anode active material to the oxide solid electrolyte was 97:3, the particle diameter of the oxide solid electrolyte was 0.8 pm; the area capacity of the ternary positive piece was larger than or equal to 4mAh/cm², the method of preparing the ternary positive piece comprises the following steps:
Ni83 was pre-mixed with LATP nanoparticles for 0.5 h in advance at the revolution speed of 40 r/min and a dispersion rotation speed of 1,500 r/min to obtain a premixed powder;
The pre-mixed powder was added with a glue solution and uniformly mixed, then added with a conductive agent according to a mass ratio of the pre-mixed powder: the binder (PVDF): the conductive agent (CNT) being 95:2:3, so as to produce an anode sizing agent;
the anode sizing agent was then coated on the aluminum foil; the coated aluminum foil was subjected to baking and cold compressing, and then tailored into a ternary positive piece.

Preparation of the negative piece: cathode powder: a cathode sizing agent was prepared by mixing a conductor (Sp), CMC and SBR according to a mass ratio of 95.8:1:1.2:, the cathode sizing agent was coated on a copper foil, the coated copper foil was subjected to baking and cold compressing, and subsequently tailored into a negative piece. The cathode powder was SL450A-SOC nanometer silicon carbon cathode material manufactured by the Liyang Tianmu Pioneer Battery Material Technology Co., Ltd.

The well-designed negative piece and ceramic diaphram (base film PP coating layer was Al₂O₃) were assembled and welded, and subjected to hi-pot test, sealing the top and the sides and then baking, and subjected to the complete encapsulation after an injection of electrolyte (the electrolyte was EC+DEC+FEC+LiPF₆), formation and capacity separation process, and lithium battery was fabricated and then subjected to electrical performance and safety testing, and the test results were shown in Table 3;

TABLE 3

| Test items | Results | Voltage before the test /V | Voltage after the test /V | Temperature /°C | Remark (test conditions) |
|---|---|---|---|---|---|
| Energy density | 300 Wh/Kg | / | / | / | 15 Ah(0.3 C/0.3 C) |
| Cycles | 1,200 cycles | / | / | / | 1C/1C |
| 3C rate discharge | ≥80% | / | / | 58 | |
| Piercing | Passing | 4.176 | 3.863 | 56 | φ5 mm, 40 mm/s |
| Heating at 180° C. for 2 h | Passing | / | / | 192 | Rate 5° C./min |
| 50% deformation compression | Passing | 4.175 | 3.887 | 48 | Rate 2 mm/s |

As can be seen from Table 3, the present disclosure improved the safety performance of the batteries by blending the oxide solid electrolyte in the high nickel ternary positive piece, the 15 Ah batteries can meet the energy density of 300 Wh/kg at the charging and discharging currents of 0.3 C/0.3 C, and the discharge retention rate of the batteries can reach 80% or more at the discharging current rate of 3 C, the safety performance of the batteries can be comprehensively improved, and can pass the piercing test, 180° C. hot box test and 50% deformation compression test, the main reasons resided in that the oxide solid electrolyte was added into the ternary anode active material, it can effectively block the contact between the ternary active particles, and improve the thermal stability of the positive piece; secondly, the oxide solid electrolyte of the present disclosure per se had a certain thermal capacity, can absorb a portion of the heat generated by the anode, alleviate overheating of the anode, and can also improve the safety performance of the battery.

### Example 15

The Example 15 merely differed from the Comparative Example 2 in that the oxide solid electrolyte had a porous spherical shape with a porosity of 50%, and the other parameters and conditions were identical to those in the Comparative Example 2.

The test results of the electrical performance and safety performance of the lithium battery obtained in the Example were shown in Table 4.

TABLE 4

| Test items | Result | Voltage before the test /V | Voltage after the test /V | Temperature /°C | Remark (test conditions) |
|---|---|---|---|---|---|
| Energy density | 307 Wh/Kg | / | / | / | 15 Ah(0.3 C/0.3 C) |
| Cycles | 1,200 cycles | / | / | / | 1 C/1 C |
| 3 C rate discharge | ≥90% | / | / | 55 | |
| Piercing | Passing | 4.175 | 3.942 | 53 | φ5 mm, 40 mm/s |
| Heating at 180° C. for 2 h | Passing | / | / | 188 | Rate 5° C./min |
| 50% deformation compression | Passing | 4.176 | 3.987 | 46 | Rate 2 mm/s |

As can be seen from Table 4, in contrast to the Comparative Example 2, the oxide solid electrolyte doped into the high nickel ternary positive piece had a porous spherical shape, the porous spherical solid electrolyte had more reaction sites, can enhance the rate capability of the battery, such that the 3 C rate discharge retention rate of the battery can reach 90% or more, and the energy density of the battery was increased to 305 Wh/kg; in addition, the porous spherical oxide solid electrolyte doped into the anode can absorb more heat generated by the positive piece, thereby favorably improving the thermal stability of the battery, and further enhancing the safety performance of the battery.

### Example 16

This Example differs from Example 15 in that the mass ratio of anode active material to oxide solid electrolyte was 95:5, the other parameters and conditions were completely identical to those in Example 15.

The test results of the electrical performance and safety performance of the lithium battery obtained in the Example were shown in Table 5.

TABLE 5

| Test items | Result | Voltage before the test /V | Voltage after the test /V | Temperature /°C | Remark (test conditions) |
|---|---|---|---|---|---|
| Energy density | 302 Wh/Kg | / | / | / | 15 Ah(0.3 C/0.3 C) |
| Cycles | 1,200 cycles | / | / | / | 1C/1C |
| 3 C rate discharge | ≥83% | / | / | 55 | |
| Piercing | Passing | 4.176 | 3.953 | 56 | φ5 mm, 40 mm/s |
| Heating at 180° C. for 2 h | Passing | / | / | 187 | Rate 5° C./min |
| 50% deformation compression | Passing | 4.175 | 3.988 | 45 | Rate 2 mm/s |

As can be seen from Table 5, the content of the solid electrolyte of the Example 16 in the anode is increased to 5% in comparison with Example 15, although the safety performance can be slightly increased, the energy density of the battery was remarkably decreased, and the 3 C rate performance of the battery was also decreased from 90% to 83%, the reason resided in that the proportion of active materials in the anode material was decreased along with an increase of the solid electrolyte, thus the energy density of the battery was reduced, and the rate performance of the battery was also deteriorated.

### Example 17

This Example differed from Example 15 in that the oxide solid electrolyte LATP was replaced with LAGP (Li_{1.5}Al_{0.5}Ge_{1.5}(PO₄)₃), the morphology of LAGP was porous and spherical, the other parameters and conditions were completely identical to those in Example 15.

The test results of the electrical performance and safety performance of the lithium battery obtained in the Example were shown in Table 6.

TABLE 6

| Test items | Result | Voltage before the test /V | Voltage after the test /V | Temperature /°C | Remark (test conditions) |
|---|---|---|---|---|---|
| Energy density | 300 Wh/Kg | / | / | / | 15 Ah(0.3 C/0.3 C) |
| Cycles | 1,200 cycles | / | / | / | 1 C/1 C |
| 3 C rate discharge | ≥89% | / | / | 59 | |
| Piercing | Passing | 4.175 | 3.982 | 55 | φ5 mm, 40 mm/s |
| Heating at 180° C. for 2 h | Passing | / | / | 189 | Rate 5° C./min |
| 50% deformation compression | Passing | 4.176 | 3.992 | 45 | Rate 2 mm/s |

As can be seen from Table 6, compared with Example 15, the porous spherical solid electrolyte LATP of the Example 17 was replaced with LAGP, the energy density of the battery cell was slightly reduced, and the rate-discharge performance was slightly decreased, the reason resided in that the electrical conductivity of LAGP is slightly inferior to LATP, thus the properties of the battery were slightly decreased.

### Example 18

This Example merely differed from Example 15 in that the dispersion rotational speed during the pre-mixing process was 500 r/min, the other parameters and conditions were completely identical to those in Example 15.

The test results of the electrical performance and safety performance of the lithium battery obtained in the Example were shown in Table 7.

TABLE 7

| Test items | Result | Voltage before the test /V | Voltage after the test /V | Temperature /°C | Remark (test conditions) |
|---|---|---|---|---|---|
| Energy density | 307 Wh/Kg | / | / | / | 15 Ah(0.3 C/0.3 C) |
| Cycles | 1,200 cycles | / | / | / | 1 C/1 C |
| 3 C rate discharge | ≥89% | / | / | 56 | |
| Piercing | Passing | 4.173 | 3.933 | 54 | φ5 mm, 40 mm/s |
| Heating at 180° C. for 2 h | Passing | / | / | 190 | Rate 5° C./min |
| 50% deformation compression | Passing | 4.173 | 3.964 | 48 | Rate 2 mm/s |

As can be seen from Table 7, the dispersing rotational speed during the premixing process of Example 18 was reduced to 500 r/min from 1,500 r/min in Example 15, the oxide solid electrolyte can be uniformly dispersed along with the decrease of the rotational speed, but the energy density and rate performance of the battery were substantially unaffected.

### Example 19

This Example differed from Example 15 in that the particle diameter of the oxide solid electrolyte was 2 µm, the other parameters and conditions were completely identical to those in Example 15.

The test results of the electrical performance and safety performance of the lithium battery obtained in the Example were shown in Table 8.

TABLE 8

| Test items | Result | Voltage before the test /V | Voltage after the test /V | Temperature /°C | Remark (test conditions) |
|---|---|---|---|---|---|
| Energy density | 306 Wh/Kg | / | / | / | 15 Ah(0.3 C/0.3 C) |
| Cycles | 1,200 cycles | / | / | / | 1 C/1 C |
| 3 C rate discharge | ≥88% | / | / | 56 | |
| Piercing | Passing | 4.173 | 3.934 | 54 | φ5 mm, 40 mm/s |
| Heating at 180° C. for 2 h | Passing | / | / | 191 | Rate 5° C./min |
| 50% deformation compression | Passing | 4.175 | 3.976 | 47 | Rate 2 mm/s |

As can be seen from Table 8, compared with Example 15, the particle diameter of the oxide solid electrolyte changed from 0.8 pm to 2 µm, the particle diameter was significantly increased, the energy density and rate performance of the battery were substantially unchanged, and the piercing performance was not significantly changed.

### Example 20

This Example differed from Example 15 in that the particle diameter of the oxide solid electrolyte was 0.5 µm, the other parameters and conditions were completely identical to those in Example 15.

The test results of the electrical performance and safety performance of the lithium battery obtained in the Example were shown in Table 9.

TABLE 9

| Test items | Result | Voltage before the test /V | Voltage after the test /V | Temperature /°C | Remark (test conditions) |
|---|---|---|---|---|---|
| Energy density | 306 Wh/Kg | / | / | / | 15 Ah(0.3 C/0.3 C) |
| Cycles | 1,200 cycles | / | / | / | 1 C/1 C |
| 3 C rate discharge | ≥86% | / | / | 58 | |
| Piercing | Passing | 4.173 | 3.930 | 55 | φ5 mm, 40 mm/s |
| Heating at 180° C. for 2 h | Passing | / | / | 189 | Rate 5° C./min |
| 50% deformation compression | Passing | 4.174 | 3.963 | 48 | Rate 2 mm/s |

As can be seen from Table 9, in comparison with Example 15, the particle diameter of the oxide solid electrolyte of the Example was changed from 0.8 pm to 0.5 µm, the particle diameter of the solid electrolyte was decreased, the energy density and rate performance of the battery were substantially unchanged, and the safety performance of the battery was substantially consistent with that in Example 15.

### Example 21

This Example differed from Example 15 in that the particle diameter of the oxide solid electrolyte was 3 µm, the other parameters and conditions were completely identical to those in Example 15.

The test results of the electrical performance and safety performance of the lithium battery obtained in the Example were shown in Table 10.

TABLE 10

| Test items | Result | Voltage before the test /V | Voltage after the test /V | Temperature /°C | Remark (test conditions) |
|---|---|---|---|---|---|
| Energy density | 306 Wh/Kg | / | / | / | 15 Ah(0.3 C/0.3 C) |
| Cycles | 1,200 cycles | / | / | / | 1C/1C |
| 3 C rate discharge | ≥88% | / | / | 58 | |
| Piercing | Passing | 4.173 | 3.912 | 56 | φ5 mm, 40 mm/s |
| Heating at 180° C. for 2 h | Passing | / | / | 189 | Rate 5° C./min |
| 50% deformation compression | Passing | 4.175 | 3.932 | 48 | Rate 2 mm/s |

As can be seen from Table 10, in comparison with Example 15, the particle diameter of the oxide solid electrolyte of the present example was changed from 0.8 pm to 3 µm, the energy density and rate performance of the battery were substantially consistent with those of Example 15, and the safety performance was not significantly lowered.

### Example 22

This Example differed from Example 15 in that the mass ratio of the anode active material to the oxide solid electrolyte was 99.9:0.1, the other parameters and conditions were completely identical to those in Example 15;

The test results of the electrical performance and safety performance of the lithium battery obtained in the Example were shown in Table 11.

TABLE 11

| Test items | Result | Voltage before the test /V | Voltage after the test /V | Temperature /°C | Remark (test conditions) |
|---|---|---|---|---|---|
| Energy density | 310 Wh/Kg | / | / | / | 15 Ah(0.3 C/0.3 C) |
| Cycles | 1,200 cycles | / | / | / | 1C/1C |
| 3 C rate discharge | ≥92% | / | / | 60 | |
| Piercing | Failed | 4.175 | / | / | φ5 mm, 40 mm/s |
| Heating at 180° C. for 2 h | Failed | / | / | / | Rate 5° C./min |
| 50% deformation compression | Passing | 4.176 | 3.876 | 65 | Rate 2 mm/s |

As can be seen from Table 11, compared with Example 15, the content of the solid electrolyte in the anode material of the Example was reduced to 0.1%, the other parameters were not changed, the energy density of the battery was significantly increased, and the rate performance was also slightly improved, but the battery safety performance including the piercing test and the hot box test of 180° C. was substantially failed, the reasons resided in that the content of the oxide solid electrolyte was reduced, the contact between the ternary active particles could not be effectively blocked, and a portion of the heat generated by the anode cannot be absorbed, resulting in the deterioration of the safety performance of the battery.

### Example 23

This Example differed from Example 15 in that the mass ratio of the anode active material to the oxide solid electrolyte was 90:10, the other parameters and conditions were completely identical to those in Example 15;

The test results of the electrical performance and safety performance of the lithium battery obtained in the Example were shown in Table 12.

TABLE 12

| Test items | Result | Voltage before the test /V | Voltage after the test /V | Temperature /°C | Remark (test conditions) |
|---|---|---|---|---|---|
| Energy density | 290 Wh/Kg | / | / | / | 15 Ah(0.3 C/0.3 C) |
| Cycles | 1,000 cycles | / | / | / | 1 C/1 C |
| 3 C rate discharge | ≥75% | / | / | 53 | |
| Piercing | Passing | 4.175 | 3.999 | 50 | φ5 mm, 40 mm/s |
| Heating at 180° C. for 2 h | Passing | / | / | 185 | Rate 5° C./min |
| 50% deformation compression | Passing | 4.176 | 3.998 | 43 | Rate 2 mm/s |

As can be seen from Table 12, in comparison with Example 15, the content of the solid electrolyte in the anode material of the Example was increased to 10%, the energy density of the battery was significantly decreased, the cycle number was decreased, and the rate performance was deteriorated, the reason resided in that the percentage of the anode active material was decreased due to the high content of the solid electrolyte, such that the electrochemical performance of the battery was deteriorated.

### Example 24

This Example differed from Example 15 in that the oxide solid electrolyte LATP in Example 15 was replaced with LLTO (Li_{0.5}La_{0.5}TiO₃), the morphology of LLTO was porous and spherical, the other parameters and conditions were completely identical to those in Example 15.

The test results of the electrical performance and safety performance of the lithium battery obtained in the Example were shown in Table 13.

TABLE 13

| Test items | Result | Voltage before the test /V | Voltage after the test /V | Temperature /°C | Remark (test conditions) |
|---|---|---|---|---|---|
| Energy density | 306 Wh/Kg | / | / | / | 15 Ah(0.3 C/0.3 C) |
| Cycles | 1,200 cycles | / | / | / | 1 C/1 C |
| 3 C rate discharge | ≥91% | / | / | 54 | |
| Piercing | Passing | 4.176 | 3.943 | 53 | φ5 mm, 40 mm/s |
| Heating at 180° C. for 2 h | Passing | / | / | 189 | Rate 5° C./min |
| 50% deformation compression | Passing | 4.175 | 3.986 | 45 | Rate 2 mm/s |

As can be seen from Table 13, compared with Example 15, the solid electrolyte was changed from LATP to LLTO, the electrochemical performance and safety performance of the battery cell were not significantly changed, because the properties of the two materials were basically consistent.

### Example 25

This Example differed from Example 15 in that the oxide solid electrolyte LATP was replaced with LZGO (Li₁₄ZnGe₄O₁₆), the morphology of the LZGO was porous and spherical, the other parameters and conditions were completely identical to those in Example 15.

The test results of the electrical performance and safety performance of the lithium battery obtained in the Example were shown in Table 14.

TABLE 14

| Test items | Result | Voltage before the test /V | Voltage after the test /V | Temperature /°C | Remark (test conditions) |
|---|---|---|---|---|---|
| Energy density | 295 Wh/Kg | / | / | / | 15 Ah(0.3 C/0.3 C) |
| Cycles | 1,200 cycles | / | / | / | 1C/1C |
| 3 C rate discharge | ≥78% | / | / | 60 | |
| Piercing | Passing | 4.174 | 3.643 | 56 | φ5 mm, 40 mm/s |
| Heating at 180° C. for 2 h | Passing | / | / | 194 | Rate 5° C./min |
| 50% deformation compression | Passing | 4.170 | 3.882 | 47 | Rate 2 mm/s |

As can be seen from Table 14, compared with Example 15, the oxide solid electrolyte LATP was replaced with LZGO, the kind of solid electrolyte was altered, the energy density of the battery was remarkably lowered, 3C rate discharge performance was deteriorated, and the safety performance of the battery was also obviously deteriorated, the reasons resided in that LZTO had a large ionic conductivity, such that the impedance of the positive piece was large, resulting in poor battery performance.

### Example 26

This Example differed from Example 15 in that the oxide solid electrolyte LATP was replaced with LLZO (Li₇La₃ZrO₂), the morphology of LLZO was porous and spherical, the other parameters and conditions were completely identical to those in Example 15.

The test results of the electrical performance and safety performance of the lithium battery obtained in the Example were shown in Table 15.

TABLE 15

| Test items | Result | Voltage before the test /V | Voltage after the test /V | Temperature /°C | Remark (test conditions) |
|---|---|---|---|---|---|
| Energy density | 302 Wh/Kg | / | / | / | 15 Ah(0.3 C/0.3 C) |
| Cycles | 1,200 cycles | / | / | / | 1 C/1 C |
| 3 C rate discharge | ≥81% | / | / | 56 | |
| Piercing | Passing | 4.174 | 3.810 | 52 | (φ5 mm,40 mm/s |
| Heating at 180° C. for 2 h | Passing | 4.171 | 3.710 | 194 | Rate 5° C./min |
| 50% deformation compression | Passing | 4.172 | 3.987 | 50 | Rate 2 mm/s |

As can be seen from Table 15, compared with Example 15, the oxide solid electrolyte LATP was changed to LLZO, the kind of solid electrolyte was changed, the energy density of the cell was reduced, the 3C rate discharge performance was deteriorated, and the ionic conductivity of LLZO was slightly reduced as compared with LATP, thereby leading to deterioration of the cell performance.

### Example 27

This Example differed from Example 15 in that the porosity of the porous spherical oxide solid electrolyte was replaced by 40%, the other parameters and conditions were completely identical to those in Example 15.

The test results of the electrical performance and safety performance of the lithium battery obtained in the Example were shown in Table 16.

TABLE 16

| Test items | Result | Voltage before the test /V | Voltage after the test /V | Temperature /°C | Remark (test conditions) |
|---|---|---|---|---|---|
| Energy density | 306 Wh/Kg | / | / | / | 15 Ah(0.3 C/0.3 C) |
| Cycles | 1,200 cycles | / | / | / | 1 C/1 C |
| 3 C rate discharge | ≥89% | / | / | 56 | |
| Piercing | Passing | 4.173 | 3.940 | 54 | (φ5 mm,40 mm/s |
| Heating at 180° C. for 2 h | Passing | 4.172 | 3.840 | 189 | Rate 5° C./min |
| 50% deformation compression | Passing | 4.173 | 3.980 | 48 | Rate 2 mm/s |

As can be seen from Table 16, compared with Example 15, the porosity of the oxide solid electrolyte LATP was changed from 50% to 40%, the energy density and rate capability of the battery cell were substantially unchanged.

### Example 28

This Example differs from Example 15 in that the porosity of the porous spherical oxide solid electrolyte was replaced by 5%, the other parameters and conditions were completely identical to those in Example 15.

The test results of the electrical performance and safety performance of the lithium battery obtained in the Example were shown in Table 17.

TABLE 17

| Test items | Result | Voltage before the test /V | Voltage after the test /V | Temperature /°C | Remark (test conditions) |
|---|---|---|---|---|---|
| Energy density | 301 Wh/Kg | / | / | / | 15 Ah(0.3 C/0.3 C) |
| Cycles | 1,200 cycles | / | / | / | 1 C/1 C |
| 3 C rate discharge | ≥82% | / | / | 57 | |
| Piercing | Passing | 4.173 | 3.901 | 55 | (φ5 mm,40 mm/s |
| Heating at 180° C. for 2 h | Passing | 4.172 | 3.766 | 191 | Rate 5° C./min |
| 50% deformation compression | Passing | 4.173 | 3.890 | 48 | Rate 2 mm/s |

As can be seen from Table 17, compared with Example 15, the porosity of the oxide solid electrolyte LATP was changed from 50% to 5%, the porosity was reduced, the active sites for reaction were decreased accordingly, the energy density and rate performance of the battery cell were slightly deteriorated, and the capacity to absorb heat generated from the anode was deteriorated due to the smaller porosity, thereby resulting in that the safety performance was also deteriorated to some extent.

### Example 29

This Example differs from Example 15 in that the mass ratio of the anode active material to the oxide solid electrolyte was 99.99:0.01, the other parameters and conditions were completely identical to those in Example 15.

The test results of the electrical performance and safety performance of the lithium battery obtained in the Example were shown in Table 18.

TABLE 18

| Test items | Result | Voltage before the test /V | Voltage after the test /V | Temperature /°C | Remark (test conditions) |
|---|---|---|---|---|---|
| Energy density | 311 Wh/Kg | / | / | / | 15 Ah(0.3 C/0.3 C) |
| Cycles | 1,200 cycles | / | / | / | 1 C/1 C |
| 3 C rate discharge | ≥93% | / | / | 60 | |
| Piercing | Failed | 4.175 | / | / | φ5 mm,40 mm/s |
| Heating at 180° C. for 2 h | Failed | / | / | / | Rate 5° C./min |
| 50% deformation compression | Failed | 4.176 | / | / | Rate 2 mm/s |

As can be seen from Table 18, compared with Example 15, the content of the solid electrolyte in the anode material of the Example was reduced to 0.01%, the other parameters were unchanged, the energy density of the battery was significantly increased, and the rate performance was slightly increased, but the battery cannot pass the safety performance test, the reason resided in that the content of the oxide solid electrolyte was reduced, the contact between the ternary active particles cannot be effectively blocked, and the heat generated at the anode could not be absorbed, such that the safety performance of the battery was deteriorated.

### Example 30

This Example differed from Example 15 in that the mass ratio of the anode active material to the oxide solid electrolyte was 85:15, the other parameters and conditions were completely identical to those in Example 15.

The test results of the electrical performance and safety performance of the lithium battery obtained in the Example were shown in Table 19.

TABLE 19

| Test items | Result | Voltage before the test /V | Voltage after the test /V | Temperature /°C | Remark (test conditions) |
|---|---|---|---|---|---|
| Energy density | 280 Wh/Kg | / | / | / | 15 Ah(0.3 C/0.3 C) |
| Cycles | 1,000 cycles | / | / | / | 1C/1C |
| 3 C rate discharge | ≥60% | / | / | 53 | |
| Piercing | Passing | 4.175 | 4.102 | 49 | (φ5 mm,40 mm/s |
| Heating at 180° C. for 2 h | Passing | / | / | 184 | Rate 5° C./min |
| 50% deformation compression | Passing | 4.176 | 4.101 | 42 | Rate 2 mm/s |

As can be seen from Table 19, compared with Example 15, the content of the solid electrolyte in the anode material of the Example was increased to 15%, the energy density of the battery cell was significantly reduced, both the cycle number and rate performance of the battery cell were significantly deteriorated, the reasons resided in that the high content of the solid electrolyte caused a reduced percentage of the anode active material, thereby resulting in a deterioration of the electrochemical performance of the battery.

### Example 31

This Example differed from Example 15 in that the particle diameter of the oxide solid electrolyte was 0.1 µm,the other parameters and conditions were completely identical to those in Example 15.

The test results of the electrical performance and safety performance of the lithium battery obtained in the Example were shown in Table 20.

TABLE 20

| Test items | Result | Voltage before the test /V | Voltage after the test /V | Temperature /°C | Remark (test conditions) |
|---|---|---|---|---|---|
| Energy density | 303 Wh/Kg | / | / | / | 15 Ah(0.3 C/0.3 C) |
| Cycles | 1,200 cycles | / | / | / | 1 C/1 C |
| 3 C rate discharge | ≥83% | / | / | 59 | |
| Piercing | Passing | 4.173 | 3.920 | 54 | (φ5 mm,40 mm/s |
| Heating at 180° C. for 2 h | Passing | / | / | 190 | Rate 5° C./min |
| 50% deformation compression | Passing | 4.174 | 3.943 | 49 | Rate 2 mm/s |

As can be seen from Table 20, in comparison with Example 15, the particle diameter of the oxide solid electrolyte of the Example was changed from 0.8 pm to 0.1 µm,the particle diameter of the solid electrolyte was reduced, the energy density and rate performance of the battery cell were decreased to some extent, the safety performance of the battery cell was substantially consistent with that of Example 15.

### Example 32

This Example differed from Example 15 in that the oxide solid electrolyte had a particle diameter of 0.01 µm,the other parameters and conditions were completely identical to those in Example 15.

The test results of the electrical performance and safety performance of the lithium battery obtained in the Example were shown in Table 21.

TABLE 21

| Test items | Result | Voltage before the test /V | Voltage after the test /V | Temperature /°C | Remark (test conditions) |
|---|---|---|---|---|---|
| Energy density | 293 Wh/Kg | / | / | / | 15 Ah(0.3 C/0.3 C) |
| Cycles | 1,200 cycles | / | / | / | 1C/1C |
| 3 C rate discharge | ≥78% | / | / | 59 | |
| Piercing | Failed | 4.172 | / | / | φ5 mm,40 mm/s |
| Heating at 180° C. for 2 h | Failed | / | / | / | Rate 5° C./min |
| 50% deformation compression | Failed | 4.174 | / | / | Rate 2 mm/s |

As can be seen from Table 21, in comparison with Example 15, the particle diameter of the oxide solid electrolyte of the Example was changed from 0.8 pm to 0.01 µm, the particle diameter of the solid electrolyte was decreased, the energy density and rate performance of the battery cell were substantially lowered, and the safety performance of the battery cell was also obviously deteriorated, mainly because the particles were smaller, the agglomeration phenomenon can be easily generated, thereby deteriorating the electrochemical performance and safety performance of the battery cell.

### Example 33

This Example differed from Example 15 in that the particle diameter of the oxide solid electrolyte was 11 µm, the other parameters and conditions were completely identical to those in Example 15.

The test results of the electrical performance and safety performance of the lithium battery obtained in the Example were shown in Table 22.

TABLE 22

| Test items | Result | Voltage before the test /V | Voltage after the test /V | Temperature/°C | Remark (test conditions) |
|---|---|---|---|---|---|
| Energy density | 285 Wh/Kg | / | / | / | 15 Ah(0.3 C/0.3 C) |
| Cycles | 1,100 cycles | / | / | / | 1 C/1 C |
| 3 C rate discharge | ≥77% | / | / | 54 | |
| Piercing | Failed | 4.173 | / | / | φ5 mm,40 mm/s |
| Heating at 180° C. for 2 h | Failed | 4.175 | / | / | Rate 5° C./min |
| 50% deformation compression | Passing | 4.175 | 3.976 | 47 | Rate 2 mm/s |

As can be seen from Table 22, compared with Example 15, the particle diameter of the oxide solid electrolyte was changed from 0.8 µm to 11 µm, the particle diameter of the oxide solid electrolyte was significantly increased, the energy density of the battery was significantly deteriorated, the cycle performance was slightly degraded, and the rate performance of the battery cell was also significantly lowered, because the particle diameter of the solid electrolyte was increased, the increased resistance of the material caused deterioration of the battery properties; in addition, the safety performance of the battery was significantly lowered, because the particle diameter of the oxide solid electrolyte was increased, its effect of blocking contact between the particles of anode was not significant, thus the contact between the ternary active particles cannot be effectively obstructed, affecting the safety performance of the battery cell.

### Example 34

This Example differed from Example 15 in that the particle diameter of the oxide solid electrolyte was 10 µm, the other parameters and conditions were completely identical to those in Example 15.

The test results of the electrical performance and safety performance of the lithium battery obtained in the Example were shown in Table 23.

TABLE 23

| Test items | Result | Voltage before the test /V | Voltage after the test /V | Temperature /°C | Remark (test conditions) |
|---|---|---|---|---|---|
| Energy density | 300 Wh/Kg | / | / | / | 15 Ah(0.3 C/0.3 C) |
| Cycles | 1,200 cycles | / | / | / | 1 C/1 C |
| 3 C rate discharge | ≥85% | / | / | 54 | |
| Piercing | Passing | 4.173 | 3.910 | 55 | (φ5 mm,40 mm/s |
| Heating at 180° C. for 2 h | Passing | 4.175 | / | / | Rate 5° C./min |
| 50% deformation compression | Passing | 4.175 | 3.976 | 47 | Rate 2 mm/s |

As can be seen from Table 23, compared with Example 15, the particle diameter of the oxide solid electrolyte was changed from 0.8 µm to 10 µm, the particle diameter was enlarged, causing deterioration of the energy density and rate performance of the battery cell, but the battery cell can still pass the safety performance test.

### Example 35

This Example differed from Example 15 in that the porosity of the porous spherical oxide solid electrolyte was replaced with 3%, the other parameters and conditions were completely identical to those in Example 15.

The test results of the electrical performance and safety performance of the lithium battery obtained in the Example were shown in Table 24.

TABLE 24

| Test items | Result | Voltage before the test /V | Voltage after the test /V | Temperature /°C | Remark (test conditions) |
|---|---|---|---|---|---|
| Energy density | 300 Wh/Kg | / | / | / | 15 Ah(0.3 C/0.3 C) |
| Cycles | 1,200 cycles | / | / | / | 1 C/1 C |
| 3 C rate discharge | ≥81% | / | / | 57 | |
| Piercing | Passing | 4.173 | 3.842 | 55 | φ5 mm,40 mm/s |
| Heating at 180° C. for 2 h | Passing | / | / | 191 | Rate 5° C./min |
| 50% deformation compression | Passing | 4.173 | 3.873 | 48 | Rate 2 mm/s |

As can be seen from Table 24, compared with Example 15, the porosity of the oxide solid electrolyte LATP was changed from 50% to 3%, the porosity was decreased, the active sites for reaction were significantly reduced, resulting in the decreased energy density of the battery cell, and degraded rate performance of the battery cell; in addition, due to the decreased porosity, the capacity of absorbing heat generated by the anode was reduced, the Lithium-ions transport performance was degraded, and the energy density was slightly decreased.

### Example 36

This Example differed from Example 15 in that the porosity of the porous spherical oxide solid electrolyte was replaced by 70%, the other parameters and conditions were completely identical to those in Example 15.

The test results of the electrical performance and safety performance of the lithium battery obtained in the Example were shown in Table 25.

TABLE 25

| Test items | Result | Voltage before the test IV | Voltage after the test IV | Temperature /°C | Remark (test conditions) |
|---|---|---|---|---|---|
| Energy density | 308 Wh/Kg | / | / | / | 15 Ah(0.3 C/0.3 C) |
| Cycles | 1,200 cycles | / | / | / | 1 C/1 C |
| 3 C rate discharge | ≥90% | / | / | 57 | |
| Piercing | Passing | 4.173 | 3.945 | 54 | φ5 mm,40 mm/s |
| Heating at 180° C. for 2 h | Passing | / | / | 184 | Rate 5° C./min |
| 50% deformation compression | Passing | 4.173 | 3.973 | 46 | Rate 2 mm/s |

As can be seen from Table 25, compared with Example 15, the porosity of the oxide solid electrolyte LATP was changed to 70% from 50%, the porosity was increased, the active sites for reaction were significantly increased, so that the energy density and rate performance of the battery cell were also improved slightly; in addition, since the porosity was increased, the capacity for absorbing heat generated from the anode was enhanced, the transport performance of Lithium-ions was improved, so that the safety performance of the battery cell can also be increased.

### Example 37

This Example differed from Example 15 in that the porosity of the porous spherical oxide solid electrolyte was replaced by 80%, the other parameters and conditions were completely identical to those in Example 15.

The test results of the electrical performance and safety performance of the lithium battery obtained in the Example were shown in Table 26.

TABLE 26

| Test items | Result | Voltage before the test /V | Voltage after the test /V | Temperature /°C | Remark (test conditions) |
|---|---|---|---|---|---|
| Energy density | 309 Wh/Kg | / | / | / | 15 Ah(0.3 C/0.3 C) |
| Cycles | 1,200 cycles | / | / | / | 1 C/1 C |
| 3 C rate discharge | ≥91% | / | / | 57 | |
| Piercing | Passing | 4.173 | 3.946 | 54 | φ5 mm,40 mm/s |
| Heating at 180° C. for 2 h | Passing | / | / | 184 | Rate 5° C./min |
| 50% deformation compression | Passing | 4.173 | 3.974 | 46 | Rate 2 mm/s |

As can be seen from Table 26, compared with Example 15, the porosity of the oxide solid electrolyte LATP was changed from 50% to 80%, the porosity was increased, the active sites for reaction were significantly increased, thus the energy density and rate performance of the battery cell were slightly improved; moreover, since the porosity was increased, the capacity of absorbing heat generated from the anode was enhanced, the Lithium-ions transport performance was improved, so that the safety performance the battery cell can also be improved; however, during a pore-forming process, the manufacturing process of the material was relatively difficult, and an excessively large porosity of the material caused the finished product ratio of the material was sharply reduced.

### Comparative Example 3

The Comparative Example differs from Example 15 in that the oxide solid electrolyte was not added into the ternary positive piece, the other parameters and conditions were completely identical to those in Example 15.

The test results of the electrical performance and safety performance of the lithium battery obtained in the Comparative Example were shown in Table 27.

TABLE 27

| Test items | Result | Voltage before the test /V | Voltage after the test /V | Temperature /°C | Remark (test conditions) |
|---|---|---|---|---|---|
| Energy density | 312 Wh/Kg | / | / | / | 15 Ah(0.3 C/0.3 C) |
| Cycles | 1,200 cycles | / | / | / | 1 C/1 C |
| 3 C rate discharge | ≥93% | / | / | 60 | |
| Piercing | Failed | 4.175 | / | / | φ5 mm,40 mm/s |
| Heating at 180° C. for 2 h | Failed | 4.173 | / | / | Rate 5° C./min |
| 50% deformation compression | Failed | 4.176 | / | / | Rate 2 mm/s |

As can be seen from Table 27, compared with Example 15, the solid electrolyte was not added in the Comparative Example 3, the energy density of the battery cell was slightly increased, and the rate performance was increased to some extent, but the battery did not pass the safety performance of the battery comprising the piercing test, the 180° C. hot box test, and substantially 50% of the deformation compression test, the reasons resided in that the oxide solid electrolyte was not contained, the contact between the ternary active particles cannot be blocked, and the heat generated by the anode cannot be absorbed, thereby causing deterioration of the safety performance of the battery cell.

As can be seen from the comparison result of Examples 15-37 and Comparative Examples 2-3, the oxide solid electrolyte was added into the ternary positive piece according to the present disclosure, the safety performance of the lithium battery obtained therefrom was remarkably improved, each of the lithium batteries in the Examples can pass the piercing test, the test of heating at 180° C. for 2 h, and the test of 50% deformation compression; and the lithium battery obtained therefrom had a high specific capacity, which may be 300 Wh/Kg or more.

As can be seen from the comparison result between Comparative Example 2 and Example 15, the present disclosure adopted a porous spherical oxide solid electrolyte, the lithium batteries obtained therefrom had higher capacity and more desirable cycle performance.

As can be seen from the comparison result of Examples 15, 17 and 24-26, the oxide solid electrolytes were preferably LATP and LLTO.

As can be seen from the comparison result of Examples 15, 16, 22, 23, 29 and 30, the percentage content by mass of the oxide solid electrolyte was 0.1-10%, preferably 1-5%, based on the sum 100% of the mass of the anode active material and the mass of the oxide solid electrolyte; if the content of the solid electrolyte was too much, the content of the anode active material was decreased, the energy density and electrochemical performance of the battery cell were affected; if the content of the solid electrolyte is too small, the safety performance of the battery cannot be pass the test.

As can be seen from the comparison results of Examples 15, 19-21 and 31-34, the particle diameter of the oxide solid electrolyte was within a range of 0.1-10 µm, preferably 0.5-3 pm; when the particle diameter of the oxide solid electrolyte was less than 0.1 µm, the particle diameter of the oxide solid electrolyte was too small, the interface resistance was increased, such that ion transport was blocked, the interface impedance was increased, the energy density of the battery was decreased; when the particle diameter of the oxide solid electrolyte was larger than 10 µm, the particle diameter was too large, its effect of blocking contact between the anode particles was not obvious, resulting in insignificant increase of the safety performance.

As can be seen from the comparison results of Examples 15, 27 and 35-37, the porosity of the porous spherical particles of the oxide solid electrolyte was within a range of 5-70%, preferably 40-70%. If the porosity was too small, the active sites of the solid electrolyte were too small, the interface resistance was excessively large, such that the Lithium-ions transport was blocked; if the porosity was too large, the difficulty of pore formation was multiplied, the yield of the material was significantly reduced.

### I. Preparation of Ternary Electrode Piece Doped and Mixed With the Oxide Solid Electrolyte

The ternary anode active material, the oxide solid electrolyte, the conductive agent and the binder were weighted according to the ratio and data listed in C1-C22 and C25-C30 of Tables 28; the ternary anode active material and oxide solid electrolyte were first vacuum pre-mixed in advance to obtain a uniformly dispersed premixed material; the uniformly dispersed premixed material was gradually added with the NMP glue solution of PVDF and uniformly blended; the conductive agents Super-P and CNT were subsequently added gradually and uniformly blended to obtain a ternary anode sizing agent having a certain fluidity; the ternary anode sizing agent was then coated on aluminum foil, and subjected to forced air drying and rolling, the obtained positive pieces were named C1, C2 ... C22, C25-C30, respectively.

Wherein the conductive agent was carbon nanotubes and conductive carbon black (CNT + Super-P, the mass ratio of carbon nanotubes to conductive carbon black was 1:2), and the binder was polyvinylidene fluoride (PVDF).

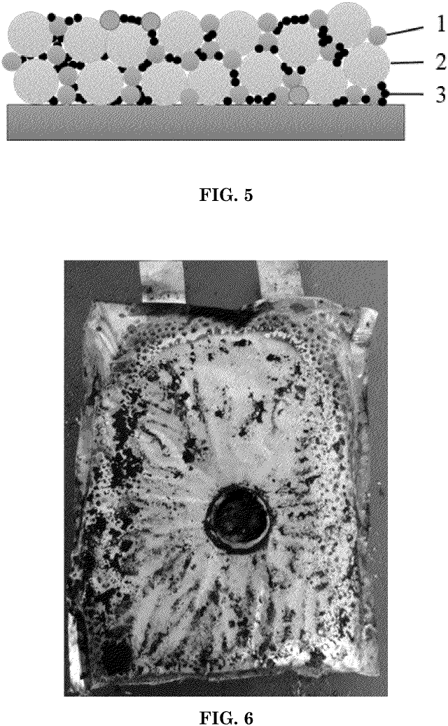

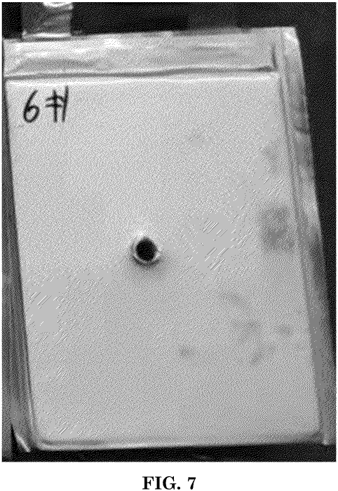

FIG. 5 was a schematic view showing an internal structure of an anode material layer in the ternary electrode piece doped and mixed with oxide solid electrolyte.

### II. Preparation of Ternary Positive Piece Without Doping and Mixing With the Oxide Solid Electrolyte

The ternary anode active material, the conductive agents, and the binder were weighted according to according to the ratio and data listed in C23 and C24 of Table 28; the ternary anode active material was gradually added with the NMP glue solution of PVDF and uniformly blended; the conductive agents Super-P and CNT (according to the mass ratio 1:2 of the CNT and conductive carbon black Super-P) were subsequently added gradually and uniformly blended to obtain a ternary anode sizing agent having a certain fluidity; the ternary anode sizing agent was then coated on aluminum foil, and subjected to forced air drying and rolling, the obtained positive pieces were named C23, C24, respectively.

Wherein the types of the conductive agent and the binder were identical with those in Example 38, except that the pre-vacuum pre-mixing step was not performed, the other operations were the same as in those in Example 38.

TABLE 28

Ternary electrode sheet parameters of high safety and high capacity

| No. | Oxide solid electrolyte | | α | Ternar Y anode materi al | Mass ratio of ternary anode active material, oxide solid electrolyte, conductive agent and binder | Pre-mixing time /h | Premixing rotation speed / rpm | | Area capa city of pole piece / mAh/ cm2 ⁻ |
|---|---|---|---|---|---|---|---|---|---|
| | Types | Particle diamete r D50/um | | | | | Revolut ion | Autorot ation | |
| C1 | LATP-1 | 0.05 | 300 | Ni80 | 93:3:2:2 | 1 | 40 | 1,000 | 4 |
| C2 | LATP-1 | 0.1 | 150 | Ni80 | 93:3:2:2 | 1 | 40 | 1,000 | 4 |
| C3 | LATP-1 | 0.5 | 30 | Ni80 | 93:3:2:2 | 1 | 40 | 1,000 | 4 |
| C4 | LATP-1 | 1 | 15 | Ni80 | 93:3:2:2 | 1 | 40 | 1,000 | 4 |
| C5 | LATP-1 | 2 | 7.5 | Ni80 | 93:3:2:2 | 1 | 40 | 1,000 | 4 |
| C6 | LATP-1 | 3 | 5 | Ni80 | 93:3:2:2 | 1 | 40 | 1,000 | 4 |
| C7 | LATP-1 | 3.6 | 4.2 | Ni80 | 93:3:2:2 | 1 | 40 | 1,000 | 4 |
| C8 | LATP-1 | 1 | 15 | Ni80 | 95.95:0.05:2:2 | 1 | 40 | 1,000 | 4 |
| C9 | LATP-1 | 1 | 15 | Ni80 | 95.9:0.1:2:2 | 1 | 40 | 1,000 | 4 |
| C10 | LATP-1 | 1 | 15 | Ni80 | 95:1:2:2 | 1 | 40 | 1,000 | 4 |
| C11 | LATP-1 | 1 | 15 | Ni80 | 91:5:2:2 | 1 | 40 | 1,000 | 4 |
| C12 | LATP-1 | 1 | 15 | Ni80 | 86:10:2:2 | 1 | 40 | 1,000 | 4 |
| C13 | LATP-1 | 1 | 15 | Ni80 | 85:11:2:2 | 1 | 40 | 1,000 | 4 |
| C14 | LATP-1 | 2 | 4 | Ni80 | 93:3:2:2 | 1 | 40 | 1,000 | 4 |
| C15 | LATP-1 | 2 | 5 | Ni80 | 93:3:2:3 | 1 | 40 | 1,000 | 4 |
| C16 | LATP-1 | 2 | 6 | Ni80 | 93:3:2:4 | 1 | 40 | 1,000 | 4 |
| C17 | LLZO-1 | 2 | 6 | Ni83 | 92:4:2:2 | 2 | 15 | 150 | 6 |
| C18 | LLZO-1 | 2 | 6 | Ni83 | 92:4:2:2 | 2 | 30 | 200 | 6 |
| C19 | LAGP-1 | 1 | 15 | Ni88 | 93:3:2:2 | 1 | 90 | 500 | 10 |
| C20 | LZGO | 1 | 15 | Ni88 | 93:3:2:2 | 4 | 60 | 2,000 | 10 |
| C21 | LLTO-1 | 1 | 15 | NCA | 93:3:2:2 | 0.5 | 60 | 1,500 | 4 |
| C22 | LOC | 1 | 15 | NCA | 93:3:2:2 | 1.5 | 80 | 800 | 6 |
| C23 | / | / | / | Ni80 | 96:2:2 | / | / | / | 4 |
| C24 | / | / | / | NCA | 96:2:2 | / | / | / | 4 |
| C25 | LSTZ | 1 | 15 | Ni83 | 93:3:2:2 | 1.5 | 50 | 1,500 | 6 |
| C26 | LATP-2 | 1 | 15 | Ni83 | 93:3:2:2 | 1.5 | 50 | 1,500 | 6 |
| C27 | LATP-3 | 1 | 15 | Ni83 | 93:3:2:2 | 1.5 | 50 | 1,500 | 6 |
| C28 | LAGP-2 | 1 | 15 | Ni83 | 93:3:2:2 | 1.5 | 50 | 1,500 | 6 |
| C29 | LLZO-2 | 1 | 15 | Ni83 | 93:3:2:2 | 1.5 | 50 | 1,500 | 6 |
| C30 | LLTO-2 | 1 | 15 | Ni83 | 93:3:2:2 | 1.5 | 50 | 1,500 | 4 |

Note: α denoted a ratio of the particle diameter D50 of the ternary anode material to the particle diameter D50 of the oxide solid electrolyte.

The ratio denoted a mass ratio of the ternary anode active material, the oxide solid electrolyte, the conductive agent and the binder.

The oxide solid electrolyte was Li_{1.4}Al_{0.4}Ti_{1.6}(PO₄)₃ (abbreviated as LATP-1), Li_{1.3}Al_{0.3}Ti_{1.7}(PO₄)₃ (abbreviated as LATP-2), Li₁.₅Al_{0.5}Ti_{1.5}(PO₄)₃ (abbreviated as LATP-3), Li_{6.4}La₃Zr_{1.6}Ta_{0.6}O₁₂ (abbreviated as LLZO-1), Li₇La₃Zr₂O₁₂ (abbreviated as LLZO-2), Li_{1.5}Al_{0.5}Ge_{1.5}(PO₄)₃ (abbreviated as LAGP-1), Li_{1.3}Al_{0.3}Ge_{1.7}(PO₄)₃ (abbreviated as LAGP-2), Li_{0.5}La_{0.5}TiOₛ (abbreviated as LLTO-1), Li_{0.34}La_{0.56}TiO₃ (abbreviated as LLTO-2), Li₃OCl (abbreviated as LOC), L1_{⅜}Sr_{7/16}Ta_{¾}Zr_{¼}O₃ (abbreviated as LSTZ), Li₁₄ZnGe₄O₁₆ (abbreviated as LZGO).

The ternary anode material was LiNi_{0.8}Co_{0.1}Mn_{o.1}O₂ (abbreviated as Ni80), LiNi₀.₈₃Co₀.₁₂Mn₀.₀₅O₂ (abbreviated as Ni83), LiNi_{0.88}Co_{0.09}Mn_{0.03}O₂ (abbreviated as Ni88), LiNi_{0.8}Co_{0.15}Al₀.₀₅O₂ (abbreviated as NCA).

### III. Preparation of Negative Pieces

In the present disclosure, the cathode may be commonly used graphite, silicon carbon, silica carbon, soft carbon, hard carbon, mesocarbon microspheres and lithium metal complex. The present disclosure did not impose requirements thereon, only if the area capacity matched with the anode during a process of preparing the battery core.

More specifically, the active substance applied as a main material of the cathode, a conductive agent and a binder were added into deionized water at a mass ratio of 96:2:2 and mixed and stirred uniformly to obtain a cathode sizing agent having a certain fluidity; the cathode sizing agent was then coated on copper foil, and subjected to forced air drying and rolling, the obtained negative pieces were named Al, A2, ... A5, respectively. Wherein the conductive agent was a mixture of carbon nanotube CNT and conductive carbon black Super-P according to a mass ratio of 1:2, and the binder was a mixture of CMC and SBR according to a mass ratio of 1: 1.

TABLE 29

Parameters of the negative piece

| No. | Main material of the cathode | Conductive agent | Binder | Area capacity / mAh/cm² |
|---|---|---|---|---|
| A1 | silicon carbon | CNT+Super-P | CMC+SBR | 4.4 |
| A2 | Silica carbon | CNT+Super-P | CMC+SBR | 6.5 |
| A3 | Natural graphite | CNT+Super-P | CMC+SBR | 4.4 |
| A4 | silicon carbon | CNT+Super-P | CMC+SBR | 6.5 |
| A5 | silicon carbon | CNT+Super-P | CMC+SBR | 11 |

The silicon carbon material was SL450A-SOC nanometer silicon carbon cathode material manufactured by the Liyang Tianmu Pioneer Battery Material Technology Co., Ltd., the silica carbon material was S450-2A silica carbon cathode material produced by the BTR New Energy Materials Co., Ltd.

### IV. Preparation of Battery Core

15Ah soft pouch battery cores were prepared according to the data listed in Table 30, the pole piece sizes: positive electrode (i.e., anode) 107 mm*83 mm, negative electrode (i.e., cathode) 109 mm *85mm.

TABLE 30

Parameters of battery cores

| | | | |
|---|---|---|---|
| No. | | Anode | Cathode |
| Comparative Example 4 | Liquid lithium battery | C23 | A1 |
| Comparative Example 5 | Liquid lithium battery | C24 | A1 |
| Comparative Example 6 | Liquid lithium battery | C1 | A1 |
| Comparative Example 7 | Liquid lithium battery | C7 | A1 |
| Example 38 | Liquid lithium battery | C2 | A1 |
| Example 39 | Liquid lithium battery | C3 | A1 |
| Example 40 | Liquid lithium battery | C4 | A1 |
| Example 41 | Liquid lithium battery | C5 | A1 |
| Example 42 | Liquid lithium battery | C6 | A1 |
| Example 43 | Liquid lithium battery | C8 | A1 |
| Example 44 | Liquid lithium battery | C9 | A1 |
| Example 45 | Liquid lithium battery | C10 | A1 |
| Example 46 | Liquid lithium battery | C11 | A1 |
| Example 47 | Liquid lithium battery | C12 | A1 |
| Example 48 | Liquid lithium battery | C13 | A1 |
| Example 49 | Liquid lithium battery | C14 | A2 |
| Example 50 | Liquid lithium battery | C15 | A2 |
| Example 51 | Liquid lithium battery | C16 | A2 |
| Example 52 | Liquid lithium battery | C17 | A4 |
| Example 53 | Liquid lithium battery | C18 | A4 |
| Example 54 | Liquid lithium battery | C19 | A5 |
| Example 55 | Liquid lithium battery | C20 | A5 |
| Example 56 | Liquid lithium battery | C21 | A3 |
| Example 57 | Liquid lithium battery | C22 | A4 |
| Example 58 | Semi-solid lithium battery | C4 | A1 |
| Example 59 | Semi-solid lithium battery | C21 | A1 |
| Example 60 | Liquid lithium battery | C25 | A4 |
| Example 61 | Liquid lithium battery | C26 | A4 |
| Example 62 | Liquid lithium battery | C27 | A4 |
| Example 63 | Liquid lithium battery | C28 | A4 |
| Example 64 | Liquid lithium battery | C29 | A4 |
| Example 65 | Liquid lithium battery | C30 | A3 |

Among them, the Examples 38-57 and 60-65 provided liquid lithium batteries, the diaphram was a double-sided ceramic diaphram, the electrolyte was a commercially conventional electrolyte, wherein the electrolyte of Comparative Examples 4-7 and Examples 38-57 was composed of 1 mol/L LiPF₆-EC/DEC (3:7, V/V) +2 wt% VC +lwt% LiDFOB; the electrolyte of Examples 60-62 was composed of 1.2 mol/L LiPF₆-EC/EMC (3:7, V/V)+2 wt% FEC +1 wt% LiDFOB; the electrolyte of Examples 63-65 was composed of 1.2 mol/L LiPF₆-EC/DEC (3:7, V/V)+2 wt% FEC +1 wt% LiDFOB +1 wt% 1,3-PS; and Examples 58-59 provided semi-solid lithium batteries, which adopted a PVDF-HFP-based gel polymer electrolyte membrane, the electrolyte was consisting of 1 mol/L LiPF₆-EC/DEC (3:7, V/V) +2 wt% VC +1 wt% LiDFOB.

### V. Tests of Battery Performance

The lithium batteries prepared in Examples 38-65 and Comparative Examples 4-7 were subjected to tests of resistance, capacity retention rate after 100 cycles of charging and discharging, and capacity retention rate after 1,000 cycles of charging and discharging, the test results are shown in Table 31. Test voltage range: 2.75-4.2 V, charging and discharging current: 1 C/1 C.

TABLE 31

Electrical properties of lithium batteries

| Examples | Energy density / Wh/Kg | Resistance / mΩ | Capacity retention rate after 100 cycles of charging and discharging /% | Capacity retention rate after 1,000 cycles of charging and discharging /% |
|---|---|---|---|---|
| Comparative Example 4 | 300.2 | 3.01 | 97.1 | 80.6 |
| Comparative Example 5 | 300.1 | 3.04 | 97.5 | - |
| Comparative Example 6 | 280.4 | 3.59 | 95.1 | - |
| Comparative Example 7 | 295.6 | 3.12 | 95.6 | - |
| Example 38 | 295.3 | 2.68 | 97.2 | - |
| Example 39 | 295.4 | 2.57 | 97.9 | - |
| Example 40 | 295.5 | 2.49 | 98.6 | 82.5 |
| Example 41 | 295.3 | 2.53 | 98.5 | - |
| Example 42 | 295.4 | 2.59 | 98.2 | - |
| Example 43 | 300.1 | 2.61 | 96.9 | - |
| Example 44 | 300.0 | 2.41 | 97.5 | - |
| Example 45 | 298.6 | 2.44 | 98.3 | - |
| Example 46 | 292.1 | 2.51 | 98.4 | - |
| Example 47 | 283.7 | 3.04 | 98.1 | - |
| Example 48 | 281.9 | 3.37 | 96.9 | - |
| Example 49 | 295.4 | 2.92 | 96.8 | - |
| Example 50 | 295.3 | 2.53 | 97.8 | - |
| Example 51 | 295.6 | 2.57 | 98.1 | - |
| Example 52 | 293.8 | 2.97 | 96.4 | - |
| Example 53 | 293.8 | 2.75 | 97.8 | - |
| Example 54 | 295.4 | 2.72 | 98.0 | - |
| Example 55 | 285.4 | 2.97 | 96.9 | - |
| Example 56 | 260.1 | 2.91 | 98.4 | 81.2 |
| Example 57 | 295.2 | 2.64 | 97.7 | - |
| Example 58 | 300.3 | 2.36 | 98.6 | - |
| Example 59 | 300.2 | 2.39 | 98.5 | - |
| Example 60 | 285.7 | 2.96 | 96.7 | - |
| Example 61 | 295.6 | 2.49 | 98.4 | - |
| Example 62 | 295.1 | 2.54 | 98.2 | - |
| Example 63 | 291.9 | 2.79 | 97.4 | - |
| Example 64 | 291.7 | 2.75 | 96.8 | - |
| Example 65 | 260.3 | 2.94 | 97.6 | - |

The present disclosure improves the safety performance of the battery cells by doping and mixing an oxide solid electrolyte into the high nickel ternary positive piece. As shown by the comparison results between Comparative Examples 4-5 and Examples 37-65, the performance of the battery cell was less affected by using the batteries prepared in the present disclosure. The main reasons resided in that the oxide solid electrolyte particles per se had a certain ion conductivity, the introduction of the oxide solid electrolyte within the content range of the solid electrolyte described in the present disclosure did not significantly hinder the ion transport capability of the anode; moreover, the endothermic effect of the oxide solid electrolyte brought down the average temperature of the anode active material during the charging and discharging process, reduced the side reactions of the ternary anode active material under the high temperature, thereby contributing to the long cycle performance of the battery cells. However, too small particle diameter of the doped oxide solid electrolyte, or an excessive amount of the doped oxide solid electrolyte would increase the internal resistance of the battery cells and reduce the energy density of the battery cells.

### VI. Piercing Safety Performance Test of the Battery Core

The lithium batteries prepared in Examples 37-65 and Comparative Examples 4-7 were subjected to piercing safety test of the Lithium-ions battery with reference to the National Standard GB/T31485-2015 of China, namely “Safety requirements and test methods for traction battery of electric vehicles”.

Piercing test: the battery cell was charged at a constant current of 1C and the constant voltage, the cut-off current was 0.05 C; a high temperature resistant steel needle with a diameter φ 5 mm was penetrated at a speed of 25±5 mm/s along a direction perpendicular to the pole piece of battery; the penetration position was preferably adjacent to a geometrical center of the pierced surface, the steel needle was retained in the battery cell; the pierced battery cell was observed for 30 min, a change in the surface temperature of the battery cell was monitored during the process, and it was recorded whether the battery cell suffered from an outbreak of a fire and an explosion, the results were shown in Table 32.

TABLE 32

Piercing test result record of battery cores

| Piercing test | Voltage before the test /V | Voltage after the test /V | Surface temperature of battery core /°C | Whether the battery cause fire and explosion | Passing rate of batteries |
|---|---|---|---|---|---|
| Comparative Example 4 | 4.181 | 0 | 793.7 | Fire and explosion | 0/5 |
| Comparative Example 5 | 4.183 | 0 | 710.3 | Fire and explosion | 0/5 |
| Comparative Example 6 | 4.189 | 3.897 | 57.8 | No fire and explosion | 5/5 |
| Comparative Example 7 | 4.19 | 0 | 589.2 | Fire and explosion | 0/5 |
| Example 38 | 4.183 | 3.879 | 53.9 | No fire and explosion | 5/5 |
| Example 39 | 4.186 | 3.982 | 52.6 | No fire and explosion | 5/5 |
| Example 40 | 4.191 | 4.105 | 50.9 | No fire and explosion | 5/5 |
| Example 41 | 4.193 | 4.089 | 47.4 | No fire and explosion | 5/5 |
| Example 42 | 4.183 | 3.955 | 51.1 | No fire and explosion | 5/5 |
| Example 43 | 4.188 | 0 | 591.3 | Fire and explosion | 0/5 |
| Example 44 | 4.184 | 3.896 | 54.2 | No fire and explosion | 5/5 |
| Example 45 | 4.188 | 3.971 | 42.7 | No fire and explosion | 5/5 |
| Example 46 | 4.183 | 4.078 | 41.3 | No fire and explosion | 5/5 |
| Example 47 | 4.185 | 3.953 | 53.1 | No fire and explosion | 5/5 |
| Example 48 | 4.183 | 3.971 | 50.6 | No fire and explosion | 5/5 |
| Example 49 | 4.187 | 0 | 601.4 | Fire and explosion | 0/5 |
| Example 50 | 4.191 | 3.876 | 47.4 | No fire and explosion | 5/5 |
| Example 51 | 4.188 | 3.862 | 52.8 | No fire and explosion | 5/5 |
| Example 52 | 4.187 | 0 | 596.9 | Fire and explosion | 0/5 |
| Example 53 | 4.186 | 3.261 | 55.7 | No fire and explosion | 5/5 |
| Example 54 | 4.184 | 3.967 | 57.3 | No fire and explosion | 5/5 |
| Example 55 | 4.189 | 3.758 | 55.3 | No fire and explosion | 5/5 |
| Example 56 | 4.191 | 3.794 | 57.6 | No fire and explosion | 5/5 |
| Example 57 | 4.185 | 3.612 | 56.5 | No fire and explosion | 5/5 |
| Example 58 | 4.192 | 4.012 | 45.8 | No fire and explosion | 5/5 |
| Example 59 | 4.193 | 4.009 | 46.9 | No fire and explosion | 5/5 |
| Example 60 | 4.184 | 3.768 | 56.2 | No fire and explosion | 5/5 |
| Example 61 | 4.191 | 4.005 | 49.4 | No fire and explosion | 5/5 |
| Example 62 | 4.193 | 4.019 | 48.5 | No fire and explosion | 5/5 |
| Example 63 | 4.185 | 3.971 | 56.7 | No fire and explosion | 5/5 |
| Example 64 | 4.184 | 3.363 | 55.4 | No fire and explosion | 5/5 |
| Example 65 | 4.190 | 3.785 | 56.7 | No fire and explosion | 5/5 |

The present disclosure improved the safety performance of the battery cells by doping and mixing the oxide solid electrolyte into the high nickel ternary positive piece. It was indicated by the comparison results of Comparative Examples 4-5 and Examples 38-42, 44-48, 50-51 and 53-65, the battery cells prepared in the present disclosure did not cause fire and explosion during the piercing process, the surface temperature of the battery core during the piercing process was within a range of 41.3-57.6° C., such that the safety performance of battery cells was improved; in contrast, the positive piece of Comparative Examples 4-5 did not add an oxide solid electrolyte, the battery cells prepared therefrom would catch fire and explode as well as thermal runaway during the piercing process, the maximum surface temperature of the battery cells may reach 793.7° C. The main reasons of the improvement resided in that the oxide solid electrolyte was added into the ternary anode active material, effectively blocking the contact between the ternary active particles, thereby improving the thermal stability of the materials; secondly, the oxide solid electrolyte of the present disclosure per se had a certain thermal capacity, and can absorb a portion of the heat generated by the anode, thereby mitigating overheating of anode.

As shown in Comparative Examples 6-7 and Examples 38-42, although the oxide solid electrolyte was added in the Comparative Examples 6-7, the particle diameter of the oxide solid electrolytes was too small to block ion transport, thereby increasing interface resistance and reducing energy density of the battery cells; when the particle diameter of the oxide solid electrolytes was too large, its effect of blocking contact between the anode particles was not obvious, resulting in insignificant improvement of safety performance, thus the produced battery cells failed to pass the piercing test. As can be seen, too small or too large particle diameter of the particles doped and mixed into the anode cannot produce the effects of improving safety performance while ensuring energy density of the battery cells.

It was demonstrated in Examples 40 and 43-48, although the positive piece of Example 43 was added with the oxide solid electrolyte, the doped and mixed amount of the oxide solid electrolyte was too small, the endothermic and heat insulation effects of the oxide solid electrolyte were not obvious, the safety performance of the battery cells was not significantly improved, the battery cells failed to pass the piercing test; the positive piece in Example 48 was added with the oxide solid electrolyte, although the battery cell passed the piercing test, the doped and mixed amount was excessive, which would decrease the energy density of the battery. As can be seen, too small or too large amount of the oxide solid electrolyte doped and mixed into the anode cannot produce the effects of improving safety performance while ensuring energy density of the battery cells.

Although the oxide solid electrolyte was added in Example 49, its particle diameter D50 was within a preferred range of 0.1-3 µm, and the added amount was within a preferred range of 0.1-10%, the ratio of D50 of the ternary anode material to D50 of the oxide solid electrolyte was less than 5, namely the particle diameters of the ternary anode material and the oxide solid electrolyte were relatively close, resulting in that the amount of the oxide solid electrolyte was insufficient to block contact between the particles of the ternary anode active material when the D50 and the added amount were within the aforementioned ranges, thus the safety performance was poor, the battery cell failed to pass the piercing test, but it resulted in the lower surface temperature of the battery core than the Comparative Examples 4-5, it demonstrated that the oxide solid electrolyte can mitigate the energy during thermal runaway process to some extent.

Although the oxide solid electrolyte was added in Example 52, its particle diameter D50 was within a preferred range of 0.1-3 µm, and the added amount was within a preferred range of 0.1-10%, the ratio of D50 of the ternary anode material to D50 of the oxide solid electrolyte was larger than 5, but the pre-mixing rotation speed was too small, the dispersion effect was poor, the particles were prone to agglomerate, resulting in poor safety performance, thus the battery cell failed to pass the piercing test; however, it caused the lower surface temperature of the battery core than the Comparative Examples 4-5, it demonstrated that the oxide solid electrolyte can mitigate the energy during thermal runaway process to some extent.

Examples 40, 55-57, 60-65 indicated that doping different oxide solid electrolytes can enhance safety performance of the battery cell at some extent, wherein the safety performance improvement from LATP was optimum; Examples 40, 61-62, and Examples 53, 64, and Examples 54, 63, and Examples 56, 65 demonstrated that for each electrolyte, the electrolyte composition had little effect on the safety performance of battery cells, each of the battery cells can successfully pass the piercing test.

Examples 60-65 showed that the positive pieces provided by the present disclosure in combination with the conventional and commercially available electrolytes can produce the effect of improving safety of the battery cores, such that the battery cores can pass the piercing test smoothly.

### VII. 180° C. Hot Box Safety Performance Test of Battery Cores

The battery cell was charged at a constant current of 1 C and the constant voltage, the cut-off current was 0.05 C; and subjected to heating at 180° C. for 2 h; the temperature rise rate was 5° C. /min, the temperature was raised to 180° C. and preserved for 2 h, and observed for 1h; the battery was denoted as passing the test if there was “no fire, no explosion”, otherwise the test result was failed; in addition, the change in the surface temperature of the battery cell during the process was monitored, the results were shown in Table 33.

TABLE 33

Results record of 180° C. hot box safety performance test of battery cores

| No. | Result | Voltage before the test /V | Voltage after the test /V | Weight loss rate of battery % | Maximum temperature of the battery surface /°C |
|---|---|---|---|---|---|
| Comparative Example 4 | Failed | 4.180 | 0 | / | 560.8 |
| Comparative Example 5 | Failed | 4.182 | 0 | / | 549.7 |
| Comparative Example 6 | Failed | 4.188 | 0 | / | 299.6 |
| Comparative Example 7 | Failed | 4.189 | 0 | / | 306.9 |
| Example 38 | Passing | 4.182 | 3.883 | 25.3 | 188.6 |
| Example 39 | Passing | 4.185 | 3.986 | 16.1 | 186.4 |
| Example 40 | Passing | 4.190 | 4.109 | 15.2 | 185.1 |
| Example 41 | Passing | 4.192 | 4.093 | 25.3 | 185.3 |
| Example 42 | Passing | 4.182 | 3.959 | 26.1 | 188.1 |
| Example 43 | Failed | 4.187 | 0 | / | 311.5 |
| Example 44 | Passing | 4.183 | 3.900 | 23.9 | 188.7 |
| Example 45 | Passing | 4.187 | 3.975 | 16.5 | 185.4 |
| Example 46 | Passing | 4.182 | 4.082 | 17.9 | 186.3 |
| Example 47 | Passing | 4.184 | 3.957 | 19.1 | 187.9 |
| Example 48 | Passing | 4.182 | 3.987 | / | 187.9 |
| Example 49 | Failed | 4.186 | 0 | / | 315.4 |
| Example 50 | Passing | 4.190 | 3.880 | 27.1 | 188.3 |
| Example 51 | Passing | 4.187 | 3.866 | 21.2 | 187.4 |
| Example 52 | Failed | 4.186 | 0 | / | 328.6 |
| Example 53 | Passing | 4.185 | 3.264 | 21.9 | 188.5 |
| Example 54 | Passing | 4.183 | 3.971 | 23.8 | 185.7 |
| Example 55 | Passing | 4.188 | 3.762 | 22.8 | 187.4 |
| Example 56 | Passing | 4.190 | 3.798 | 21.1 | 186.6 |
| Example 57 | Passing | 4.184 | 3.616 | 24.1 | 185.1 |
| Example 58 | Passing | 4.191 | 4.009 | 14.8 | 181.4 |
| Example 59 | Passing | 4.192 | 4.012 | 15.1 | 182.8 |
| Example 60 | Passing | 4.185 | 3.778 | 20.9 | 185.3 |
| Example 61 | Passing | 4.190 | 3.995 | 15.9 | 183.1 |
| Example 62 | Passing | 4.192 | 3.998 | 16.1 | 183.3 |
| Example 63 | Passing | 4.186 | 3.969 | 17.5 | 184.2 |
| Example 64 | Passing | 4.185 | 3.669 | 17.8 | 184.5 |
| Example 65 | Passing | 4.189 | 3.729 | 18.1 | 185.1 |

The present disclosure improved the safety performance of the battery cells by doping and mixing the oxide solid electrolyte in the high nickel ternary positive piece. Comparative Examples 4-5 and Examples 38-42, 44-47, 50-51 and 53-65 showed that the surface temperature of batter core was within a range of 181.4-188.7° C. when the battery cells prepared by the present disclosure were subjected to the 180° C. hot box test, the weight loss ratio of the battery cells was within a range of 15.1%-27.1%, none of the battery cells suffered from fire and explosion. In contrast, the oxide solid electrolyte was not added into the positive piece of Comparative Examples 4-5, the battery cells prepared therefrom suffered from thermal runaway, the maximum surface temperature of the battery cells reached 560.8° C. The main reasons resided in that the oxide solid electrolyte was added into the ternary anode active material, it effectively blocked contact between the ternary active particles. Secondly, the oxide solid electrolyte of the present disclosure itself had a certain thermal capacity, can absorb a portion of the heat generated by the anode and alleviates the anode overheating. Thus the battery cells can successfully pass the 180° C. hot box test.

It was apparently indicated from Comparative Examples 6-7 and Examples 38-42, although the oxide solid electrolyte was added in Comparative Examples 6-7, the particle diameter of the oxide solid electrolytes was too small to block ion transport, the interface resistance was increased, and the energy density of the battery cells was decreased; if the particle diameter of the oxide solid electrolytes was too large, its effect of blocking contact between the anode particles was not obvious, the safety performance was not significantly improved, thus the battery cells failed to pass the 180° C. hot box test. As can be seen, too small or too large particle diameter of the particles doped and mixed into the anode cannot produce the effects of improving safety performance while ensuring energy density of the battery cells.

It can be seen from Examples 40 and 43-48 that although the oxide solid electrolyte was added into the positive piece of Example 43, the effect of improving safety performance cannot be favorably achieved if the amount of the oxide solid electrolyte doped into the positive piece was too small or too large; when the doped amount of the oxide solid electrolyte was too small, the endothermic and heat insulation effects of the solid electrolyte were not obvious, the safety performance was not significantly improved; the oxide solid electrolyte was added into the positive piece in Example 48, although the battery cell obtained therefrom passed the 180° C. hot box test, the doped amount was excessively high, it would reduce the energy density of the battery cell.

Although the oxide solid electrolyte was added in Example 49, its particle diameter D50 was within a preferred range of 0.1-3 µm, and the added amount was within a preferred range of 0.1-10%, the ratio of D50 of the ternary anode material to D50 of the oxide solid electrolyte was less than 5, namely the particle diameters of the ternary anode material and the oxide solid electrolyte were relatively close, resulting in that the amount of the oxide solid electrolyte was insufficient to block contact between the particles of the ternary anode active material when the particle diameter and the added amount were within the aforementioned ranges, thus the safety performance was poor, the battery cell failed to pass the 180° C. hot box test; but it resulted in the lower surface temperature of the battery core than the Comparative Examples 4-5, it demonstrated that the oxide solid electrolyte can mitigate the energy during thermal runaway process to some extent.

Although the oxide solid electrolyte was added in Example 52, its particle diameter D50 was within a preferred range of 0.1-3 µm, and the added amount was within a preferred range of 0.1-10%, the ratio of D50 of the ternary anode material to D50 of the oxide solid electrolyte was larger than 5, but the pre-mixing rotation speed was too small, the dispersion effect was poor, the particles were prone to agglomerate, resulting in poor safety performance, thus the battery cell failed to pass the 180° C. hot box test; however, the surface temperature of the battery core was lower than the Comparative Examples 4-5, it demonstrated that the oxide solid electrolyte can alleviate the energy during thermal runaway process to some extent.

In the Examples provided by the present disclosure, the nickel content x of the ternary anode material LiNiₓCo_{y}M_{1-x-y}O₂ was 0.80, 0.83 or 0.88, the higher was the nickel content of the high nickel ternary anode material, the worse was its thermal stability. As can be seen from Examples 54-55, under a circumstance that the positive piece provided by the present disclosure had a high nickel content (x=0.88), the corresponding battery core still can smoothly pass the hot box test; for the anode active material with a low nickel content (x=0.6-0.8), the positive piece provided in the present disclosure can also ensure desirable safety performance.

Examples 40, 55-57, 60-65 demonstrated that doping with different oxide solid electrolytes can improve the safety performance of the battery cells to a certain extent, wherein the improvement effect of safety performance from the LATP was the best; Examples 40, 61-62, and Examples 53, 64, and Examples 54, 63, and Examples 56, 65 showed that for each electrolyte, the electrolyte composition has little effect on the battery safety performance.

Examples 60-65 indicated that the positive pieces provided by the present disclosure in combination with the conventional and commercially available electrolytes can produce the effect of improving safety of the battery cores, such that the battery cores can pass the hot box test smoothly.

The foregoing content merely sets forth the preferred embodiments of the present disclosure, it shall be indicated that the ordinary skilled person in the art can make some improvements and modifications without departing from the inventive concept of the present disclosure, the improvements and modifications shall be deemed to be within the protection scopes of the present disclosure.

1. An positive piece for a lithium battery, wherein the positive piece for a lithium battery is doped and mixed with a lithium-rich compound, and the lithium-rich compound is at least one selected from the group consisting of a lithium-rich manganese-based solid solution, a lithium-rich solid electrolyte and a lithium-separated silicon oxide.

2. The positive piece for a lithium battery of claim 1, wherein the lithium-rich compound is capable of pulling away Lithium-ions under extreme conditions of battery;
preferably, the extreme conditions of battery include at least one of overcharging, high temperature, piercing, compressing, internal short circuiting, external short circuiting, thermal abuse or overheating;
preferably, the lithium-rich manganese-based solid solution is represented by the molecular formula xLi₂MnO_{3•}(1-x) LiMO₂, wherein 0 < x ≤ 1, and M is at least one selected from Ni, Co or Mn.

3. The positive piece for a lithium battery of claim 1 or 2, wherein the lithium-rich solid electrolyte is selected from Li₇La₃Zr₂O₁₂ and materials obtained after subjecting Li₇La₃Zr₂O₁₂ to doping with other element, wherein the doping element is at least one selected from the group consisting of La, Nb, Sb, Ga, Te, W, Al, Sn, Ca, Ti, Hf and Ta.

4. The positive piece for a lithium battery of any one of claims 1-3, wherein the lithium-separated silicon oxide is represented by the molecular formula LiₓSiO_{y}, wherein x is selected from a range of 1.4-2.1, and y is selected from a range of 0.9-1.1.

5. The positive piece for a lithium battery of any one of claims 1-4, wherein the lithium-rich compound has a particle diameter D50 within a range of 0.1-10 µm, preferably a range of 0.5-2 pm.

6. The positive piece for a lithium battery of any one of claims 1-5, wherein the percentage content by mass of the lithium-rich compound is 0.1-20%, preferably 1-5%, based on the sum 100% of the mass of the anode active material and the lithium-rich compound in the positive piece for a lithium battery.

7. The positive piece for a lithium battery of any one of claims 1-6, wherein the positive piece for a lithium battery has an area capacity larger than or equal to 4 mAh/cm²;
preferably, the anode active material in the positive piece for a lithium battery is represented by the molecular formula LiNiₓCo_{i-x-y}M_{y}O₂, where x ≥ 0.8, y < 0.2, and M is any one of Mn, Al or Mg, or a combination of at least two thereof.

8. A method of preparing the positive piece for a lithium battery of any one of claims 1 to 7 compring: pre-mixing anode active material with lithium-rich compound to obtain a premixed powder; and
blending the premixed powder, glue solution and conductive agent to obtain an anode sizing agent; and
coating the anode sizing agent on a current collector to obtain a coated current collector, subjecting the coated current collector to drying, cold pressing and tableting process, so as to prepare the positive piece for a lithium battery;
preferably, the pre-mixed powder, the glue solution and the conductive agent are blended in such a manner that the glue solution is added to the premixed powder, the conductive agent is then added to obtain the anode sizing agent.

9. A battery comprising the positive piece for a lithium battery of any one of claims 1-7;
preferably, the battery further comprises a negative piece, a cathode active material in the negative piece is selected from silicon oxide and/or silicon carbon;
preferably, the negative piece comprises a cathode active material, a conductive agent, a thickening agent and a binder;
preferably, the battery further comprises a diaphram.

10. The battery of claim 9, wherein the diaphram is selected from diaphrams coated with a ceramic interlayer;
preferably, the diaphrams have a thickness of 10-40 µm and a porosity of 20-60%.

11. A ternary positive piece for a lithium battery having both high safety and high capacity comprising a current collector and an anode active material layer disposed on a surface of the current collector, wherein the anode active material layer comprises an oxide solid electrolyte capable of transporting Lithium-ions, the oxide solid electrolyte is composed of porous spherical particles.

12. The ternary positive piece of claim 11, wherein the porous spherical particles have a porosity within a range of 5-70%, preferably 40-70%.

13. The ternary positive piece of claim 11 or 12, wherein the oxide solid electrolyte has a particle diameter within a range of 0.1-10 µm, preferably 0.5-3pm.

14. The ternary positive piece of any one of claims 11-13, wherein the percentage content by mass of the oxide solid electrolyte is 0.1-10%, preferably 1-5%, based on the sum 100% of the mass of the anode active material and the oxide solid electrolyte in the anode active material layer.

15. The ternary positive piece of any of claims 11-14, wherein the oxide solid electrolyte comprises at least one selected from the group consisting of a NASICON structure, a perovskite structure, an inverse perovskite structure, a LISICON structure and a garnet structure;
preferably, the NASICON structure is at least one selected from the group consisting of Li₁+ₓAlₓGe₂₋ₓ(PO₄)_{3,} isomorphic heteroatom-doped compounds of Liᵢ₊ₓAlₓGe₂₋ₓ(PO₄)₃, Li_{1+y}Al_{y}Ti_{2-y}(PO₄)₃ and isomorphic heteroatom-doped compounds of Liᵢ₁+_{y}Al_{y}Ti_{2-y}(PO₄)₃;
preferably, the perovskite structure is at least one selected from the group consisting of Li_{3z}La_{⅔-z}TiO₃, isomorphic heteroatom-doped compounds of Li_{3z}La_{⅔-}_{z}TiO₃, Li_{⅜}Sr_{7/16}Ta_{¾}Hf_{¼}O₃, isomorphic heteroatom-doped compounds of Li_{⅜}Sr_{7/16}Ta_{¾}Hf_{¼}O₃, Li_{2a-b}Sr₁₋ₐTa_{b}Zn_{1-b}O₃ and isomorphic heteroatom-doped compounds of Li_{2a-b}Sr₁₋ₐTa_{b}Zr_{1-b}O₃;
preferably, the inverse perovskite structure is at least one selected from the group consisting of Li₃₋₂ₓMₓHa1O, isomorphic heteroatom-doped compounds of Li₃₋₂ₓM_{X}Ha1O, Li₃OC1 and isomorphic heteroatom-doped compounds of Li₃OC1; wherein Hal comprises Cl and/or I, and M is any one of Mg²⁺, Ca²⁺, Sr²⁺, or Ba²⁺, or a combination of at least two thereof;
preferably, the LISICON structure is at least one selected from the group consisting of Li_{4-c}Si_{1-c}P_{c}O₄, isomorphic heteroatom-doped compounds of Li_{4-c}Si_{1-c}P_{c}O₄, Li₁₄ZnGe₄O₁₆, and isomorphic heteroatom-doped compounds of L1₁₄ZnGe₄O₁₆;
preferably, the garnet structure is selected from Li_{7-d}La₃Zr_{2-d}O₁₂ and/or isomorphic heteroatom-doped compounds of Li_{7-d}La₃Zr_{2-d}O₁₂.

16. The ternary positive piece of any one of claims 11-15, wherein the ternary positive piece has an area capacity larger than or equal to 4mAh/cm².

17. The ternary positive piece of any one of claims 11-16, wherein the anode active material in the anode active material layer is selected from a high nickel ternary material;
preferably, the high nickel ternary material comprises lithium nickel cobalt manganate and/or lithium nickel cobalt aluminate.
Preferably, the lithium nickel cobalt manganate is represented by the molecular formula LiNiₓCoMn₁₋ₓ_{–y}O₂ and the lithium nickel cobalt aluminate is represented by the molecular formula LiNiₓCoA1₁₋ₓ_{–y}O₂, wherein x ≥ 0.6.

18. A method of preparing the ternary positive piece of any one of claims 11-17 comprising:
Pre-mixing an anode active material with an oxide solid electrolyte to obtain a pre-mixed powder; and
adding a glue solution and a conductive agent into the pre-mixed powder to obtain a mixture, and blending the mixture to form an anode sizing agent; and
coating the anode sizing agent on a current collector to obtain a coated current collector, subjecting the coated current collector to drying so as to prepare the ternary positive piece.

19. A lithium battery comprising the ternary positive piece of any one of claims 11-17.

20. The lithium battery of claim 19, wherein the lithium battery comprises any one of a liquid lithium battery, a semi-solid lithium battery and an all-solid lithium battery;
preferably, the liquid lithium battery comprises the ternary positive piece of any one of claims 11-17, a negative piece and a liquid electrolyte;
preferably, the semi-solid lithium battery comprises the ternary positive piece of any one of claims 11-17, a negative piece, and an electrolyte layer containing a liquid electrolyte material;
preferably, the solid-state lithium battery comprises the ternary positive piece of any one of claims 11-17, a negative piece and a solid electrolyte layer;
preferably, the solid electrolyte in the solid electrolyte layer is at least one selected from the group consisting of a polymer solid electrolyte, an oxide solid electrolyte and a sulfide solid electrolyte.

21. A ternary positive piece for a lithium battery comprising a current collector and an anode material layer disposed on a surface of the current collector, the anode material layer comprising ternary anode active material particles, a conductive agent, a binder, and oxide solid electrolyte particles capable of conducting Lithium-ions;
the positive piece has an area capacity larger than or equal to 4 mAh/cm²;
the oxide solid electrolyte particles has a particle diameter D50 within a range of 0.1-3 µm.

22. The positive piece of claim 21, wherein the oxide solid electrolyte particles have a particle diameter D50 within a range of 0.5-2 µm;
preferably, the content of the ternary anode active material particles is 80-98%, based on a total mass 100% of the ternary anode active material particles, the conductive agent, the binder and the oxide solid electrolyte particles;
preferably, the content of the oxide solid electrolyte is 0.1-10%, preferably 1-5%, based on the total mass 100% of the ternary anode active material particles, the conductive agent, the binder and the oxide solid electrolyte particles;
preferably, the content of the conductive agent is 0.1-8%, based on the total mass 100% of the ternary anode active material particles, the conductive agent, the binder and the oxide solid electrolyte particles;
preferably, the content of the binder is 0.1-10%, based on the total mass 100% of the ternary anode active material particles, the conductive agent, the binder and the oxide solid electrolyte particles.

23. The positive piece of claim 21 or 22, wherein the oxide solid electrolyte particles comprise any one of the following compounds or a combination of at least two thereof: Li₁₊ₓ₁Alₓ₁Ge₂₋ₓ₁(PO₄)₃ of the NASICON structure or isomorphic heteroatom-doped compounds thereof; Li₁+_{X2}Alₓ₂Ti₂₋ₓ₂(PO₄)₃ of the NASICON structure or isomorphic heteroatom-doped compounds thereof; Li₃ₓ₃La_{⅔-x3}TiO₃ of the perovskite structure or isomorphic heteroatom-doped compounds thereof; Li_{⅜}Sr₇₁ᵢ₆Ta_{¾}Hf_{¼}O₃ of the perovskite structure or isomorphic heteroatom-doped compounds thereof; Li_{2x4-y1}Sr₁₋ₓ₄Ta_{y1}Zr_{1-y1}O₃ of the perovskite structure or isomorphic heteroatom-doped compounds thereof; Li₃₋₂ₓ₅Mₓ₅Ha1O and Li₃OC1 of an inverse perovskite structure or isomorphic heteroatom-doped compounds thereof; Li₄₋ₓ₆Si₁₋ₓ₆Pₓ₆O₄ of the LISICON structure or isomorphic heteroatom-doped compounds thereof; Li₁₄ZnGe₄O₁₆ of the LISICON structure or isomorphic heteroatom-doped compounds thereof; Li₇₋ₓ₇La₃Zr₂_{–x}₇O₁₂ of the garnet structure or isomorphic heteroatom-doped compounds thereof; wherein 0<xl≤0.75, 0<x2≤0.5, 0.06≤x3≤0.14, 0.25≤y1≤1, x4=0.75y1, 0≤x5≤0.01, 0.5≤x6≤0.6; 0≤x7≤1; wherein M includes any one of Mg²⁺, Ca²⁺, Sr²⁺ or Ba²⁺ or a combination of at least two thereof, and Hal is element Cl or I;
preferably, the oxide solid electrolyte particles comprise Li₁₊ₓ₂Alₓ₂Ti₂₋ₓ₂(PO₄)₃ and/or Li₇_{–x}₇La₃Zr₂₋ₓ₇O_{12,}preferably Li₁₊ₓ₂Alₓ₂Ti₂₋ₓ₂(PO₄)_{3.}

24. The positive piece of any one of claims 21-23, wherein the ternary anode active material particles comprise lithium nickel cobalt manganate and/or lithium nickel cobalt aluminate;
preferably, the ternary anode active material particles are represented by the molecular formula LiNiₓCo_{y}M_{1-x-y}O_{2,} M is Mn and/or Al, and x ≥ 0.6.
Preferably, the conductive agent includes any one of Super-P, KS-6, carbon black, carbon nanofiber, CNT, acetylene black or grapheme, or a combination of at least two thereof, preferably a combination of carbon nanotube and Super-P;
preferably, the binder comprises any one of polyvinylidene fluoride, polyvinylidene fluoride-hexafluoropropylene, polyethylene oxide, polytetrafluoroethylene, or a combination of at least two thereof.

25. The positive piece of any one of claims 21-24, wherein a ratio of the particle diameter D50 of the ternary anode active material particles to the particle diameter D50 of the oxide solid electrolyte particles is larger than or equal to 5.

26. A method of preparing the positive piece of any one of claims 21-25 comprising:
S1: pre-mixing anode active material particles and oxide solid electrolyte particles to obtain a pre-mixed material, wherein the anode active material particles comprising ternary anode active material particles;
S2: adding a glue solution as a binder to the premixed material to obtain a primary sizing agent;
S3: adding a conductive agent to the primary sizing agent to obtain a mixture, and blending the mixture to obtain a secondary sizing agent;
S4: coating the secondary sizing agent on a current collector to obtain a coated current collector, controlling an area capacity of the positive piece to be larger than or equal to 4mAh/cm², subjecting the coated current collector to baking and rolling, so as to prepare the positive piece.

27. The method of claim 26, wherein the pre-mixing is a vacuum pre-mixing or a pre-mixing performed at a dew point ≤ -30° C.;
Preferably, the pre-mixing and blending process is carried out in a ball mill or a blender;
preferably, the pre-mixing and blending process is performed by using a self-rotating and revolving blender having a revolution speed ≥ 20 rpm, independently preferably 30-90 rpm, and an autorotation speed ≥ 200 rpm, independently preferably 500-2,000 rpm;
preferably, the pre-mixing is performed for 0.5-4h, preferably 1-2h;
Preferably, the dew point is ≤ -45° C., further preferably ≤ -60° C.

28. A method for improving the safety performance of a lithium battery compring: adding oxide solid electrolyte particles having a particle diameter D50 within a range of 0.1-3 µm and dispersing the oxide solid electrolyte particles between anode active material particles during the preparation process, the positive piece has an area capacity larger than or equal to 4mAh/cm².

29. A lithium battery comprising the positive piece of any one of claims 21-25.

30. The lithium battery of claim 29, wherein the lithium battery comprises a liquid lithium battery or a semi-solid lithium battery;
preferably, the liquid lithium battery comprises the positive piece of any one of claims 21-25, a negative piece and a liquid electrolyte;
preferably, the semi-solid lithium battery comprises the positive piece of any one of claims 21-25, a negative piece and an electrolyte layer containing a liquid electrolyte.
